(19) United States
(12) Patent Application Publication
(10) Pub. No.: US 2025/0382431 A1
(43) Pub. Date: Dec. 18, 2025

(54) Recycling of Artificial Turf

(71) Applicant: ExxonMobil Technology and Engineering Company, Baytown, TX (US)

(72) Inventors: Kapil Kandel, Humble, TX (US); Ali A. Kheir, Houston, TX (US); Stephen T. Cohn, Coldspring, TX (US); Win Rubens, Temse (BE); Rainer Kolb, Kingwood, TX (US)

(21) Appl. No.: 19/235,948

(22) Filed: Jun. 12, 2025

Related U.S. Application Data
(60) Provisional application No. 63/659,122, filed on Jun. 12, 2024.

(51) Int. Cl. C08J 11/10; B29B 17/04; C10G 67/00

(52) U.S. Cl. CPC C08J 11/10; B29B 17/04; C10G 67/00; B29B 2017/0496

(57) ABSTRACT

Systems and methods are provided for recycling of artificial turf, including, in one embodiment, a method comprising: providing a turf feed including a sized carpet composition; subjecting the turf feed to thermal treatment to produce a liquid effluent including hydrocarbons; and removing entrained solids and heavies from the liquid effluent via a separator, wherein the heavies have an average density greater than the average density of the liquid effluent that enters the separator.

### CROSS REFERENCE TO RELATED APPLICATIONS

This application claims the benefit of and priority to U.S. Provisional Application No. 63/659,122 filed Jun. 12, 2024, the disclosure of which is incorporated herein by reference.

### FIELD

Systems and methods are provided for recycling of artificial turf.

### BACKGROUND

Artificial turf is used as ground cover in a number of applications, including sports fields, playgrounds, and residential and commercial ground cover, among others. The artificial turf generally includes a carpet portion, one or more backing materials, one or more infill materials, and an optional shock pad. The carpet portion includes vertical fibers or upstanding ribbons that resemble blades of the artificial turf and often is made from thermoplastic materials. The fibers of the carpet portion may be referred to as turf fibers. The one or more backing materials can include a primary backing material and a secondary backing material. Among other materials, the primary backing material may include a thermoplastic, such as polypropylene, and the secondary backing material may include a polyurethane or latex, among others. The one or more infill materials simulates the soil in natural turf and can include an inorganic filler, such as sand. The one or more infill materials can also include a second infill material, such as granulated thermoset rubbers. The artificial turf optionally includes a shock pad underneath the backing materials.

While artificial turf is a suitable substitute for natural turf, it has a limited-service life and is often removed and replaced with a new turf material. Due to the large amount of artificial turf currently in service, there is a need to reuse and/or recycle some or all of the turf components. However, the options for turf recycling are limited. Mechanical recycling is difficult due to the composite nature of the artificial turf, typically including a thermoplastic component (e.g., turf fibers, primary backing material, etc.) and a thermoset component (e.g., secondary backing material). These mixtures are known to yield low value in mechanical recycling. Furthermore, because the artificial turf typically includes an inorganic filler as infill material, contamination of the turf fibers with this inorganic filler makes conventional mechanical recycling processes for carpets unsuitable. In addition, thermoset rubbers are also known to be difficult to recycle mechanically, especially if contaminated with inorganic filler material. Because the artificial turf further can include thermoset rubbers as a second infill material, mechanical recycling is further complicated.

### SUMMARY

Disclosed herein is an example method of providing an artificial turf feed that includes a carpet composition of an artificial turf; subjecting the artificial turf feed to thermal treatment to produce an effluent comprising hydrocarbons; and removing heavies and entrained solids from the effluent via a separator, wherein an average density of the heavies is greater than an average density of the effluent that enters the separator.

Further disclosed herein is an example method of recycling artificial turf, including providing a turf feed having a sized carpet composition of the artificial turf; thermally treating the turf feed to produce liquid, vapor, and char, wherein the liquid comprises pyrolysis oil or wax, or both; separating the liquid from the vapor and the char; and hydrotreating the liquid to give a cracker feed for a steam cracker, wherein olefin content of the cracker feed as measured by bromine number is less than 50% of the olefin content of the liquid upstream of the hydrotreating.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 a cross-sectional view diagram of an artificial turf.

FIG. 2A and FIG. 2B are diagrams of processes for conditioning artificial turf.

FIG. 3 is a diagram of a recycling process for artificial turf.

FIG. 4 is a diagram of steam cracking process train to integrate with the process of FIG. 3.

FIG. 5 is a depiction of pellets of artificial turf in Example 1 prior to being subjected to the pyrolysis.

FIG. 6 is a depiction of the pyrolysis yield of liquid in Example 1.

FIG. 7 is a depiction of the pyrolysis yield of char in Example 1.

FIG. 8 is a plot of char % after pyrolysis versus the ash weight percent (wt %) in the artificial turf before pyrolysis in Example 1.

FIG. 9 depicts heavies and pyoil (pyrolysis oil) in Example 2.

FIG. 10 is a plot of temperature versus cumulative mass for the three samples in Example 3.

FIG. 11 is a bar chart of % carbon composition of total sample for the three samples in Example 3.

### DETAILED DESCRIPTION

In various embodiments, systems and methods are provided for recycling of artificial turf. In some embodiments, a process for recycling of artificial turf includes subjecting a turf feed (artificial turf feed) to thermal treatment (e.g., pyrolysis, cracking, etc.) to produce hydrocarbons. The turf feed may be prepared from the artificial turf. The thermal treatment of the turf feed generally involves applying heat. Thus, the turf feed is heated in the thermal treatment. The thermal treatment (e.g., in a thermal treatment reactor, such as a pyrolysis reactor or cracker) may thermally pyrolyze or crack the turf feed. In some implementations, optionally other plastic waste and/or conventional pyrolysis feed (e.g., conventional cracking feed) may be co-fed with the turf feed to the thermal treatment.

Some aspects of the present disclosure are directed to recycling techniques (e.g., involving physical preparation and thermal recycling, as well as chemical recycling, etc.) for the recovered artificial turf including the carpet part, the performance infill, the supporting infill, and the shock pad (if present), or any combinations thereof, of the artificial turf. In implementations, a thermal treatment unit (e.g., a first thermal treatment unit) can be utilized to thermally convert the artificial turf (turf feed) into gas, liquid, and solid. As mentioned, the thermal treatment unit (e.g., as or including a thermal treatment reactor) may be a pyrolysis unit or cracker system, and the like. The thermal treatment reactor may be, for example, a pyrolysis reactor, a cracker, etc.

The liquid and gas discharged from the thermal treatment unit may be separated from each other. The liquid may be hydrotreated to reduce contaminants and hydrogenate olefins, diolefins, and aromatics in the liquid making the liquid an appropriate feed to integrate with a steam cracker and/or refinery for conversion to monomer. Optionally, depending on the turf feed composition, the liquid stream from the thermal treatment unit can be hydrofined to make wax products. In implementations, the gas can be fed to a steam cracker, depending on the composition of the gas. In implementations, the gas from the thermal treatment unit can be purified and separated to recover starting monomers, and the like. Solid in the artificial turf feed may be removed in the char phase from the thermal treatment unit in the thermal treatment of the artificial turf feed, which can help to avoid a pre-wash of the artificial turf or artificial turf feed. In implementations, the char can include coke (e.g., generally polyaromatic).

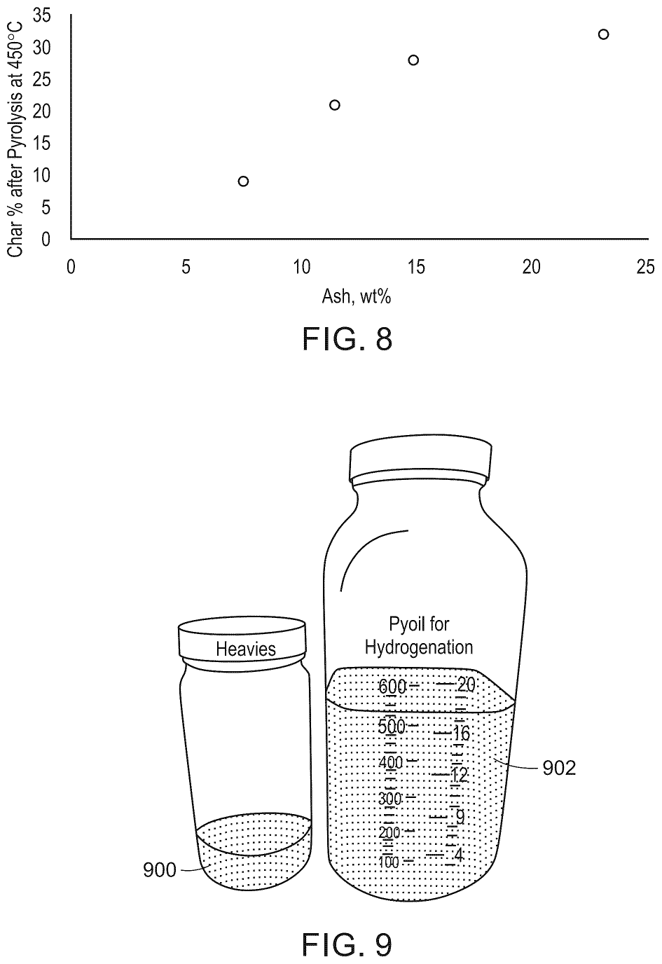

An advantage of thermal treatment of the turf feed can be the management of inorganic material (e.g., sand infills or dirt) in the turf feed by rejection as char. The char can be purged and disposed separately generally without affecting the downstream process. In implementations, this can avoid a pre-wash of artificial turf or turf feed, which can be costly, for example, because of the extent of water use (and wastewater management) associated with a pre-wash. FIG. 8 indicates beneficially that the ash content in the starting artificial turf feed can correlate well with the amount of char resulting in the thermal treatment reactor (e.g., first thermal treatment reactor).

Downstream in the system can include an additional thermal treatment unit(s), such as an additional pyrolysis unit or steam cracker. Treatment such as steam cracking can be viewed as pyrolysis (cracking without oxygen). Gas (e.g., cleaned gas) and/or liquid (e.g., clean liquid) from upstream in the system can fed to a steam cracker. Thus, a downstream second thermal unit can be a steam cracker in embodiments.

Artificial turf is utilized as ground cover for sports fields, playgrounds, residential and commercial landscaping, and the like. The artificial turf is generally made from different components, such as a carpet part, backing part(s), infill material(s), and optionally a shock pad. The carpet part includes vertical fibers or upstanding ribbons that can resemble the grass blades of the artificial grass and often include thermoplastic materials. The backing part can include a primary material and a secondary material. The primary backing material can be a thermoplastic, such as polypropylene (PP). The secondary backing (binding component) can include a polyurethane (PU) or latex, among others. Often, artificial turf includes a stabilizing infill material and a performance infill as well. The stabilizing infill material can include an inorganic filler, such as sand. The performance infill can include granulated thermoset materials such as rubber granules including styrene-butadiene rubber (SBR) granules or used tire granules, and the like. In some cases, there is also a shock pad underneath the carpet structure.

Artificial turf can be referred to as artificial grass, artificial lawn, synthetic turf, synthetic grass, synthetic lawn, and the like. Artificial turf can refer to synthetic or artificial surface materials used as ground covers. Such ground cover can include, for example, sports fields for contact or non-contact sports, residential or non-residential landscaping including for sports and entertainment venues, and so on. The composition and manufacture of artificial turf or ground cover can vary depending on the specific function it is intended to perform. As discussed, in some embodiments, the artificial turf can include a carpet part, a first backing material, and a second backing material. The artificial turf can also include various kinds of particulate infill materials that can include granular material of finely divided rock and mineral particles (e.g., sand), ground synthetic or natural rubber, ground elastomers, ground plastomers, or other ground plastic or thermosetting materials.

The recycling of artificial turf by way of thermal treatment can be performed, for example, by performing several processes on the artificial turf. First, the artificial turf can be conditioned to provide a turf feed (which can be labeled as artificial turf feed). The turf feed includes one or more components of the artificial turf, including sized turf fibers, sized primary backing material, and sized secondary backing material. The term “sized” can mean crushed, chopped, shredded, ground, and/or pelletized, and the like. Thus, the term “sized” can mean reduced particle size. In some embodiments, the physical processing can be utilized to reduce the median particle size. The turf feed can include at least a portion of the infill material, such as a first infill material of an inorganic filler (e.g., sand) and/or a second infill material of a thermoset rubber. The second infill material can be labeled as rubber infill.

Second, the turf feed can be passed into a thermal treatment environment (e.g., a pyrolysis environment or a pyrolysis unit). The thermal treatment can include, for example, pyrolysis (e.g., fluidized bed pyrolysis or other type of pyrolysis), cracking (thermal cracking), and/or coking (fluidized coking or delayed coking), and so on. The thermal treatment can be in thermal treatment reactors generally. The output of the thermal treatment can be subjected to further processing, such as separations, distillation, hydrotreating, hydrolysis steam cracking, etc. to generate products.

In implementations, a carrier or conventional feeds for pyrolysis or cracking can be co-fed with the turf feed to the thermal treatment. A conventional pyrolysis feed can be fed for pyrolysis or cracking as a co-feed along with the turf feed, and in implementations, can be a carrier in conveyance of the turf feed to the thermal treatment reactor. An example of an indigenous feed that may be co-fed with the turf feed is refinery crude vacuum residue (vacuum resid) that is a product of vacuum distillation as a byproduct of crude oil distillation. Vacuum resid may include, for example, long-chain paraffins, polynuclear aromatics, and hydrocarbons with various heteroatoms, and so forth. Vacuum resid may be characterized by high content of heteroatoms such as nitrogen, sulfur, and oxygen, distributed in functional groups. Other conventional pyrolysis feeds as co-feed are applicable.

In some embodiments, the recycling of the artificial turf by way of thermal treatment provides advantages relative to mechanical processing. As previously noted, mechanical processing of artificial turf is challenging due to its complex nature of many different materials, such as thermoset materials, thermoplastic materials, rubber granules, and/or inorganic fillers. Advantageously, embodiments provide a technique for recycling of artificial turf while producing desirable products. Since the chemical composition of artificial turf is chemically compatible with a thermal treatment environment (e.g., cracking, pyrolysis such as fluidized bed pyrolysis or other pyrolysis, etc.), the turf is processed in the thermal treatment to produce desirable products (e.g., hydrocarbons), such as gases (e.g., monomers, etc.), naphtha, gas oils, etc. In addition, when processed in a thermal treatment environment, in accordance with one or more embodiments, the inorganic filler in the feed to the thermal treatment feed is segregated into char (that can also include coke), thus allowing for recycling of turf feeds contaminated with the inorganic filler (giving char) that would otherwise be problematic to recycle. By handling the inorganic filler in the recycling, embodiments address a problem with recycling of the artificial turf.

Thermal treatment of the turf feed including the carpet part (turf fibers, such as PP grass), primary backing material (e.g., thermoplastic such as PP), rubbers (e.g., second infill material, etc.), and the like, can give circularity to different products, e.g., ethylene (C2═), propylene (C3═), wax, lubes, etc. The liquid stream recovered as product from the thermal treatment can include, for example, up to 10 weight percent (wt %) of heavies (heavy components having greater density [average density] than the remainder of the liquid stream). In implementations, the average density can be the average density of the range of compounds present weighted based on volume. The average density may be total mass divided by total volume. As a definition, the average density of a mixture may be characterized by multiplying the densities of each compound by the volume of the respective compound, then dividing the result by the sum of all the volumes. The heavies and any entrains solids can be removed from the liquid stream, for example, by separation via a separator vessel, such as a distillation tower (vessel with distillation trays), hydrocyclone, centrifuge, etc. Further, the heavies can have contaminants including halides and other contaminants. Thus, removal of the heavies via separator can facilitate halide management, such as with respect to capturing chloride (Cl), bromide (Br), and fluoride (F). Therefore, embodiments can include contaminant removal by a separator vessel before hydrotreating.

Hydrotreating (e.g., hydrogenation) of the liquid product from the thermal treatment may be implemented to manage contaminants. The contaminants may be altered or converted via the hydrotreating, such that the compounds are no longer categorized as a contaminant. Hydrotreating of the liquid product stream can be implemented to manage (e.g., convert) reactives, such as olefins and diolefins, to meet downstream steam cracker or refinery integration specifications (specs). Hydrotreating of aromatics in the liquid product stream to naphtha can make the liquid product stream more appropriate as feed to a steam cracker. Naphtha is a generic term applied generally to a refined or partially refined petroleum fraction with an approximate boiling range, for example, between 50° C. and 205° C. Naphtha can have fraction boiling, for instance, between 30° C. and 200° C. and include mainly straight-chained and cyclic aliphatic hydrocarbons, being molecules, for example, with 5 to 12 carbon atoms. Naphtha generally includes aromatic compounds (aromatics).

Removal of infills (e.g., inorganic filler such as sand) and dirt solids to char in the thermal treatment of the turf feed (without risking downstream processes) can be a benefit of the thermal treatment (e.g., standalone pyrolysis). Also, such removal of inorganic solids to char can be a benefit in facilitating avoiding pre-water wash of the artificial turf to remove inorganic solids prior to thermal treatment that can be costly in water management. In some implementations, the turf feed can include inorganic filler, for example, in the range of 1 wt % to 30 wt %.

An embodiment is a method of recycling artificial turf, including providing a turf feed including at least a carpet composition (e.g., turf fibers) and rubber infill. In implementations, the artificial turf and the turf feed includes at least 10 wt % of the rubber infill. In implementations, as discussed, the artificial turf further includes an inorganic filler. The method includes thermally treating (e.g., heating, pyrolyzing, cracking, etc.) the turf feed in a thermal reactor to produce liquid, gas, and char. The liquid includes, for example, hydrocarbons, pyrolysis oil, wax, and/or aromatic compounds, or any combinations thereof. The char can include inorganic solids and coke (generally organic solid). The method includes separating the liquid from the gas and char, and hydrotreating (e.g., hydrogenating) the liquid. Heavies (which may be called or include gums) and residual solids may be removed from the liquid. Optionally, heavies (heavy components, e.g., generally hydrocarbons) and residual solids may be removed (separated) from the liquid, such as in a separator vessel, prior to (upstream of) hydrotreating the liquid. In implementations, the heavies removed are 1 wt % to 10 wt % of the liquid and have an average density greater than the average density of the remainder of the liquid.

The liquid may be hydrotreated to give feed, for example, to a cracker (e.g., steam cracker). The hydrotreating may upgrade the quality of liquid by converting olefins and diolefins in the liquid to paraffins. Such may reduce gum formation in the subsequent cracking (e.g., steam cracking) of the liquid. The hydrotreating may provide for contaminant management of the liquid. The hydrotreating may manage (e.g., convert, remove, etc.) contaminants in the liquid. The contaminants can include heteroatoms (an atom not carbon or hydrogen), such as elemental oxygen (O), elemental nitrogen (N), elemental sulfur (S), and so on. The contaminants can be halides. The hydrotreating may convert halides into hydrogen halides. The contaminants may include metals, such as organic metals and/or particulate metals, and the like. In implementations, the hydrotreating may involve more than one bed of hydrotreating catalyst, and in which one of the catalyst beds is a sacrificial catalyst bed to remove contaminants and/or hydrogenated contaminants.

In some implementations, the [1] liquid (e.g., pyrolysis oil, wax, etc.) as entering (just upstream of) the hydrotreating and [2] as discharged from the hydrotreating (e.g., for feed to a steam cracker) may have substantially the same boiling curve and substantially the same specific gravity, and wherein the hydrotreating reduces the olefin content (as measured by the bromine number) of the liquid by at least 50% or at least 90% (by weight, volume, or molar), e.g., in the ranges of 50%-99% reduction or 90% to 99.5% reduction. In implementations, the liquid (e.g., pyrolysis oil, wax, etc.) that discharges as product or effluent of the hydrotreating has less than 50% (e.g., in the range of 1% to 50%) or less than 10% (e.g., in the range of 1% to 10%) of the olefin content of the liquid (e.g., pyrolysis oil, wax, etc.) that enters the hydrotreating as feed to be hydrotreated. The phrase “substantially the same” means less than 5% deviation. In some implementations, the [1] liquid (e.g., pyrolysis oil, wax, etc.) as entering (just upstream of) the hydrotreating and [2] as discharged from the hydrotreating (e.g., for feed to a steam cracker) do not have substantially the same boiling curve nor substantially the same specific gravity, nor is the olefin content reduced by at least 50% or 90%.

In implementations, the chlorine content of the liquid (e.g., pyrolysis oil, wax, etc.) is reduced by at least 50% (e.g., in the range of 50% to 95%) by the hydrotreating of the liquid. In implementations, the liquid that discharges as product or effluent of the hydrotreating has less than 50% (e.g., in the range of 5% to 50%) of the chlorine (chloride) content of the that enters the hydrotreating as feed to be hydrotreated. In other implementations, the hydrotreating of the liquid does not reduce the chlorine content of the liquid by at least 50%.

Another embodiment is a method of recycling artificial turf, including providing a turf feed including at least a carpet composition (e.g., turf fibers) and rubber infill, thermally treating (e.g., pyrolyzing, etc.) the turf feed to produce a liquid that includes pyrolysis oil or wax, or both. The method includes separating the liquid from gas and char of the thermal treatment, optionally removing heavies and residual solids from the liquid, and hydrotreating the liquid such as at a pressure greater than 400 pounds per square inch gauge (psig) (e.g., in a range of 400 psig to 2000 psig) in presence of a hydrotreating catalyst to obtain a cracker feed. The hydrotreating may remove or convert contaminants and add hydrogen. The hydrotreating catalyst can include metals, metal oxide, and/or metal sulfide. The hydrotreating catalyst can include, for example, molybdenum (Mo), cobalt (Co), nickel (Ni), palladium (Pd), tungsten (W), nickel (Ni), or any combinations thereof. The support in the hydrotreating catalyst may include, for example, alumina (aluminum oxide or Al₂O₃), silica (silicon oxide or SiO₂), magnesia (magnesium oxide or MgO), zirconia (zirconium dioxide or ZrO₂), or zeolites (hydrated aluminosilicates of the alkaline and alkaline-earth metals), or any combinations thereof. Optionally, in some implementations, the cracker feed discharged from the hydrotreating may have substantially the same boiling curve and substantially same specific gravity as the liquid (pyrolysis oil and/or wax) that enters the hydrotreating to be hydrotreated, and wherein the olefin content of the cracker feed as measured by the bromine number is reduced by at least 90% compared to the pyrolysis oil or wax fed to the hydrotreating.

While artificial turf is a suitable substitute for natural turf, it has a limited-service life and is often removed and replaced with a new turf material. Due to the large amount of artificial turf currently in service, there is a need to reuse and/or recycle some or all of the turf components. However, the options for turf recycling are limited. As discussed, mechanical recycling is difficult due to the composite nature of the artificial turf, typically including a thermoplastic component (e.g., turf fibers, primary backing material, etc.) and a thermoset component (e.g., secondary backing material). These mixtures are known to yield low value in mechanical recycling. Furthermore, because the artificial turf typically includes an inorganic filler as infill material, contamination of the turf fibers with this inorganic filler makes conventional mechanical recycling processes for carpets generally unsuitable. In addition, thermoset rubbers are also known to be difficult to recycle mechanically, especially if contaminated with inorganic filler material. Because the artificial turf further can include thermoset rubbers as a second infill material, mechanical recycling is further complicated.

### Artificial Turf

As indicated, artificial turf is used as ground cover in a number of applications, including sports fields, playgrounds, and residential and commercial ground cover, among others. Artificial turf generally includes a number of components, including turf fibers, a primary backing material, a secondary backing material, an infill material, and/or a shock pad. In some embodiments, the turf fibers are coupled to the primary backing material and extend upward from a top side of the primary backing material resembling blades of grass. In some embodiments, the infill material is dispersed between the turf fibers extending from the primary backing material. In some embodiments, the second backing material is coupled to a bottom side of the primary backing material to hold the turf fibers on the primary backing material. Artificial turf also includes the optional shock pad beneath the secondary backing material.

The turf fibers include any material suitable for use in manufacture of the artificial turf. Examples of suitable materials for the turf fibers include thermoplastic materials, such as polyolefins, polyesters, polyamides, or other suitable thermoplastics and blends thereof. In some embodiments, the turf fibers include polyethylene, polypropylene, polyamide 6, polyamide 6,6, polyethylene terephthalate, or combinations thereof.

In some embodiments, the turf fibers are coupled to the primary backing material. The turf fibers can be coupled to the primary backing material through any suitable means. For example, the turf fibers are tufted or sewn into the primary backing material. By way of further example, adhesives may be used for securing the turf fibers. In some embodiments, the primary backing material includes one or more thermoplastic materials. Examples of suitable thermoplastic materials for the primary backing material include polyolefins, polyamides and polyesters. In some embodiments, the primary backing material includes polyethylene, polypropylene, polyamides, polyethylene terephthalate, or combinations thereof.

In some embodiments, the artificial turf further includes the secondary backing material. The secondary backing material is coupled to a bottom side of the primary backing material to hold the turf fibers on the primary backing material. In some embodiments, the secondary backing material is coated onto the bottom side of the primary backing material. Examples of suitable secondary backing materials includes thermoset materials. In some embodiments, the secondary backing material includes polyurethane, a thermoset elastomer (e.g., natural or synthetic rubber latex), an acrylic adhesive, or combinations thereof.

In some embodiments, the artificial turf further includes an infill material. The infill material is dispersed between the turf fibers, for example, to function as a ballast. The infill material may include a single infill material or a combination of infill materials. In some embodiments, the infill material includes a first infill material and a second infill material. Examples of suitable first infill materials include inorganic materials (inorganic filler), such as sand, gravel, or other inorganic materials. Examples of suitable second infill materials include cork and polymeric materials, such as polymer beads, thermoset rubbers, thermoplastic elastomers, thermoplastic vulcanizates, thermoplastic materials, and combinations thereof. In some embodiments, the second infill material includes ground tire rubber, crumb rubber, SBR, polybutadiene rubber, ethylene propylene diene methylene (EPDM) rubber, neoprene rubber, and combinations thereof. In some embodiments, combinations of suitable infill materials are used.

In some embodiments, the artificial turf further includes a shock pad. Where used, the shock pad is placed, for example, underneath the secondary backing material. The shock pad functions as a shock absorbing material. In some embodiments, the shock pad includes polyurethane, polyvinyl chloride foam plastic, polyurethane foam, a rubber, a closed-cell crosslinked polyethylene foam, a polyurethane underpad having voids, elastomer foams of polyvinyl chloride, polyethylene, polyurethane, and polypropylene, and combinations thereof.

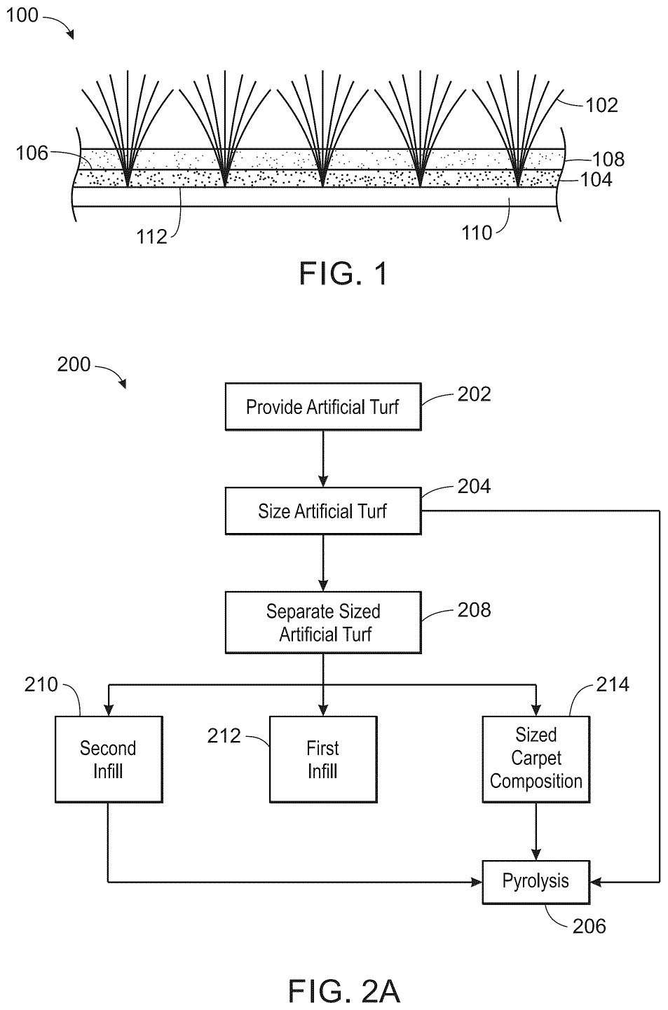

FIG. 1 illustrates a cross-sectional view of an artificial turf 100 in accordance with one or more embodiments. In the illustrated embodiment, the artificial turf 100 includes turf fibers 102 coupled to a primary backing material 104. The turf fibers 102 extends from a top side 106 of the primary backing material 104 with an infill material 108 dispersed between the turf fibers 102. A second backing material 110 is coupled to a bottom side 112 of the primary backing material 104. While not shown, the artificial turf 100 may include an optional shock pad underneath the second backing material 110.

### Artificial Turf Conditionings

Embodiments include conditioning of the artificial turf into a turf feed. In some embodiments, the turf feed includes a carpet composition, for example, the artificial turf with separation of at least a portion of the infill materials. The artificial turf can be obtained from a number of sources. In some embodiments, the artificial turf is obtained from a collection site after its removal from a field or other installation location. The collection site includes post-consumer artificial turf suitable for conditioning into a turf feed. In some embodiments, the artificial turf is sorted based on type of turf fibers. In some embodiments, the artificial turf is baled.

Conditioning of the artificial turf includes performing a physical processing step on the artificial turf to prepare it for a pyrolysis environment. In some embodiments, conditioning includes sizing of the artificial turf to reduce its particle size. For example, having a small particle size can facilitate transport of the solids and/or reduce the likelihood of incomplete conversion in cracking. Examples of physical processing can include sizing of the artificial turf, for example, by crushing, chopping, shredding, grinding (including cryogenic grinding), pelletizing, and so on. Thus, the term “sizing” can mean crushing, chopping, shredding, grinding, and/or pelletizing, and the like. The term “sizing” can mean reducing particle size. In some embodiments, the physical processing can be utilized to reduce the median particle size. In some embodiments, the physical processing can be utilized to reduce the median particle size of the turf feed to in the ranges of 0.01 millimeters (mm) to 50 mm, 0.1 to 50 mm, 0.1 to 30 mm, 0.1 to 20 mm, 5.0 mm, or 0.1 mm to 5.0 mm, or 0.01 mm to 3.0 mm, or 0.1 mm to 3.0 mm, or 0.01 mm to 3.0 mm, or 0.1 mm to 3.0 mm, or 1.0 mm to 5.0 mm, or 1.0 mm to 3.0 mm. The maximum particle size can be reduced.

For determining a median particle size, the particle size is defined as the diameter of the smallest bounding sphere that contains the particle. Optionally, after the physical processing, the turf feed (e.g., including thermoset resin, etc.) can be sieved or filtered to remove larger particles. In some embodiments, the sieving or filtering can be used to reduce the maximum particle size to 10 mm or less, or 5.0 mm or less.

In some embodiments, a turf feed for thermal treatment (e.g., pyrolysis, etc.) includes a sized artificial turf without any additional separation. In other embodiments, the sized artificial turf is separated into one or more components to provide a turf feed. The components may be separated, for example, by specific gravity, size, and/or shape. Examples of separation techniques include sieving, specific sieving by specific gravity, and/or separation by air swirling (e.g., cyclone separators). Different fractions of the sized artificial turf may be obtained that contain or more different components of the artificial turf. Polymeric turf components are suitable for recycling by way of pyrolysis, in accordance with one or more embodiments. It should be understood that certain components (such as sand) would not be generally converted but instead partitioned as char. The turf feed may include, for example, one or more of sized turf fibers, sized primary backing material, sized secondary backing material, first infill material, second infill material, and/or sized shock pad. Even though it may be desired to separate the turf fibers from the artificial turf to provide a turf feed of only turf fibers, the turf fibers may be contaminated with other components of the artificial turf so that the separate turf fibers further include additional components, such as primary backing material, secondary backing material, first infill material, second infill material, and/or shock pad. In some embodiments, the infill materials are separated from the other turf components to form a carpet composition for the turf feed, wherein the carpet composition includes one or more of the turf fibers, primary backing material, secondary backing material, and/or shock pad. It should be understood that, while it may be desirable to separate the carpet composition from the infill materials for recycling the carpet composition may be contaminated with the infill materials, such as the first infill material (inorganic material) to provide a turf feed including the inorganic filler.

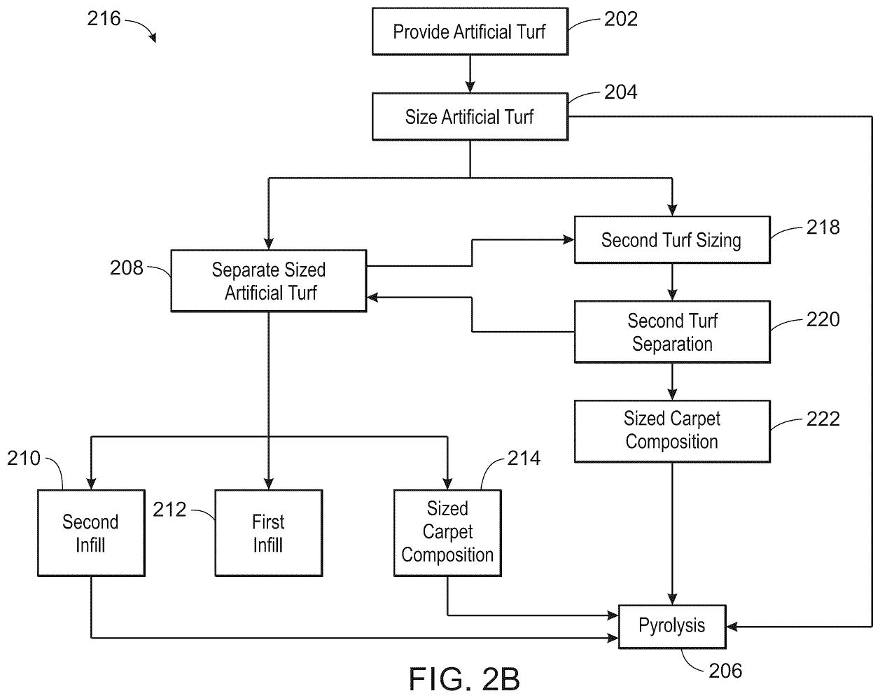

FIG. 2A illustrates a process 200 for conditioning artificial turf. As illustrated, the process 200 includes providing an artificial turf, as shown at block 202. The artificial turf is then sized at block 204 to provide sized artificial turf. As previously described, any suitable technique may be used to size the artificial turf to provide a sized artificial turf with a reduced particle size, including crushing, chopping, cutting, shredding, and grinding. In some embodiments, the sized artificial turf is used as a turf feed for thermal treatment (e.g., pyrolysis, etc.) as shown in block 206 without further separation. The sized artificial turf may be subjected to thermal treatment (e.g., pyrolyzed) separately, in combination with one or more turf fractions, and/or in combination with a conventional pyrolysis (e.g., cracking) feedstock. In some embodiments, the sized artificial turf is separated into one or more fractions, as indicated with respect to the feeds to block 206. For example, the infill material is separated from the sized carpet composition to provide at least separated second infill material at block 210, separated first infill material (e.g., shown as separated inorganic filler at block 212), and sized composition at block 214. The sized carpet composition at block 214 may include one or more of turf fibers, primary backing material, secondary backing material, and/or shock pad. In some embodiments, the sized carpet composition may also be separated into different fractions, such as a turf fiber fraction, a primary backing fraction, and/or a secondary backing fraction. As illustrated, example embodiments include pyrolysis of the sized carpet composition and/or second infill material at block 206, which may be thermally treated (e.g., pyrolyzed) separately, in combination with one another, or in combination with a conventional pyrolysis or cracking feedstock.

FIG. 2B illustrates a process 216 for conditioning artificial turf. As illustrated, the process 216 includes providing an artificial turf, as shown at block 202. The artificial turf is then sized at block 204 to provide sized artificial turf. As previously described, any suitable technique may be used to size the artificial turf to provide a sized artificial turf with a reduced particle size, including crushing, chopping, shredding, and grinding. In some embodiments, the sized artificial turf is used as a turf feed for thermal treatment (e.g., heated, pyrolysis, cracking etc.) as shown in block 206 without further separation. The sized artificial turf may be pyrolyzed separately, in combination with one or more turf fractions and/or with a conventional pyrolysis or cracking feedstock. In some embodiments, the sized artificial turf is separated into one or more fractions, as indicated in the depicted process 216. For example, the infill material is separated from the sized carpet composition to provide at least separated second infill material at block 210, separated first infill material (e.g., shown as separated inorganic filler at block 212), and sized carpet composition at block 214. The sized carpet composition at block 214 may include one or more of turf fibers, primary backing material, secondary backing material, and/or shock pad. In some embodiments, the sized carpet composition may also be separated into different fractions, such as a turf fiber fraction, a primary backing fraction, and/or a secondary backing fraction. As illustrated, example embodiments include thermal treatment (e.g., pyrolysis) of the sized carpet composition and/or separated second infill material at block 206, which may be subjected to thermal treatment (e.g., pyrolysis) separately, in combination with one another, and/or in combination with a conventional pyrolysis (e.g., cracking) feedstock.

In some embodiments, the sized artificial turf from block 204 is provided to a second turf sizing at block 218 for further size reduction. In some embodiments, the sized carpet composition separated in block 208 is provided to the second turf sizing at block 218 for further size reduction. The output of block 218 with further size reduction is provided to a second turf separation, at block 220, in accordance with present embodiments. In the second turf separation of block 220, the first infill material (e.g., inorganic filler) may be separated from the sized turf composition to provide a turf composition, at block 222, which may then be subjected to thermal treatment at block 206. The separated first infill material from block 220 is optionally returned to the separating of block 208.

### Feed for Thermal Treatment

In accordance with present embodiments, a turf feed (artificial turf feed) is subjected to thermal treatment (e.g., pyrolyzed, etc.) to produce hydrocarbons. In some embodiments, the turf feed is co-pyrolyzed with a conventional pyrolysis feed (e.g., cracking feed). The turf feed (and any conventional pyrolysis feed as a co-feed and/or a carrier) may added to a thermal treatment reactor (e.g., a pyrolysis reactor or cracker, etc.). In implementations, the turf feed (e.g., with the co-feed and/or carrier) may be conveyed (e.g., pneumatically conveyed) to the thermal reactor. In implementations, the turf feed and the conventional pyrolysis feed may be conveyed or otherwise placed into a mixing tank and combined in the mixing tank (vessel) before being conveyed or otherwise fed to the thermal reactor.

The turf feed fed includes one or more components of an artificial turf. For example, the turf feed includes a sized carpet composition including one or more of turf fibers, primary backing material, secondary backing material, and/or sized backing pad. In some embodiments, the carpet composition is contaminated with an infill material such that the turf feed further comprises an infill material, for example, the first infill material of the inorganic material.

In some embodiments, the sized carpet composition is included in the turf feed in any suitable amount. For example, the sized carpet composition may be included in the turf feed in an amount of 0.1% to 100% by weight of the turf feed. In some embodiments, the sized carpet composition is included in the turf feed in an amount 1% to 99%, 1% to 95%, 1% to 90%, 1% to 50%, 10% to 100%, 10% to 90%, 10% to 50%, 40% to 100%, 40% to 90%, 50% to 100%, or 50% to 90% by weight of the turf feed.

In some embodiments, the sized turf fibers are included in the carpet composition in any suitable amount. For example, the sized turf fibers may be included in the carpet composition in an amount of 0.1% to 100% by weight of the carpet composition. In some embodiments, the sized turf fibers are included in the carpet composition in an amount 1% to 99%, 1% to 95%, 1% to 90%, 1% to 50%, 10% to 100%, 10% to 90%, 10% to 50%, 40% to 100%, 40% to 90%, 50% to 100%, or 50% to 90% by weight of the carpet composition.

In some embodiments, sized primary backing material is included in the carpet composition. For example, the sized primary backing material may be included in the carpet composition in an amount of 0.10% to 100% by weight of the turf feed. In some embodiments, the sized primary backing material is included in the carpet composition in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the carpet composition.

In some embodiments, sized secondary backing material is included in the carpet composition. For example, the sized secondary backing material may be included in the carpet composition in an amount of 0.1% to 100% by weight of the carpet composition. In some embodiments, the sized secondary backing material is included in the carpet composition in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the carpet composition.

In some embodiments, a sized backing pad is included in the carpet composition. For example, the sized backing pad may be included in the carpet composition in an amount of 0.1% to 100% by weight of the carpet composition. In some embodiments, the sized backing pad is included in the carpet composition in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the carpet composition.

In some embodiments, the infill materials are included in the turf feed. The infill material includes a first infill material (e.g., an inorganic filler) and/or a second infill material (e.g., thermoset rubbers, thermoset elastomers, etc.). Where present, the infill materials may be included in the turf feed in an amount of 0.1% to 100% by weight of the turf feed. In some embodiments, the infill materials are included in the turf feed in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the turf feed. In some embodiments, it may be desirable to limit the amount of the first infill material of an inorganic filler in the turf feed. For example, the first infill material may be present in the turf feed in an amount of 50% or less by weight of the turf feed. In some embodiments, the first infill material is present in the turf feed in an amount of 40%, 30%, 20%, 15%, 10%, or less by weight of the turf feed. For example, the first turf infill may be present in an amount of about 0.10% to about 40%, about 0.1% to about 30%, about 0.1% to about 20%, about 0.1% to about 15%, about 0.1% to about 10%, about 0.1% to about 5%, about 1% to about 20%, about 1% to about 10%, about 1% to about 5%, or about 1% to about 3% by weight of the turf feed. In some embodiments, the second infill may be present in the turf feed in an amount of 0.1% to 100% by weight of the turf feed. In some embodiments, the second infill material is included in the turf feed in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the turf feed.

In some embodiments, the turf feed includes a sized carpet composition and an infill material, wherein the sized carpet composition includes one or more of turf fibers, primary backing material, secondary backing material, and/or a backing pad. For example, the turf feed includes a sized carpet composition and a second infill material (e.g., polymeric materials) of in an amount of about 50% or less by weight of the turf feed. In some embodiments, the turf feed includes sized turf fibers, a sized primary backing material, a sized secondary backing material, and an infill material, wherein the infill material is present in the turf feed in an amount of about 20% or less by weight of the turf feed.

In some embodiments, the turf feed includes a first infill material of an inorganic filler and a second infill of a polymeric material, wherein the first infill material is present in the turf feed in an amount of about 30% of less by weight of the turf feed. In some embodiments, the turf feed further includes at least one of sized turf fibers, sized primary backing material, or sized secondary backing material.

As previously described, one or more components of the artificial turf may be sized to reduce a median particle size for cracking. In some embodiments, the turf feed has a median particle size of 0.01 mm to 50 mm, 0.1 to 50 mm, 0.1 to 30 mm, 0.1 to 20 mm, 5.0 mm, or 0.1 mm to 5.0 mm, or 0.01 mm to 3.0 mm, or 0.1 mm to 3.0 mm, or 0.01 mm to 3.0 mm, or 0.1 mm to 3.0 mm, or 1.0 mm to 5.0 mm, or 1.0 mm to 3.0 mm to reduce the maximum particle size. In some embodiments, turf feed has a maximum particle size of 20 mm or less, 10 mm or less, or 5.0 mm or less.

Optionally, a carrier fluid can be included in the turf feed to assist with introducing the turf into the thermal treatment (e.g., pyrolysis) environment or unit. A conventional pyrolysis feed may be fed with the turf feed to the thermal treatment and can act as a carrier fluid of the turf feed. For introduction into a thermal treatment environment, it can be convenient in implementations for the feedstock to be in the form of a slurry. If a carrier fluid is employed for transporting the turf feed, any suitable fluid can be used. Examples of carrier fluids can include, for example, a wide range of petroleum or petrochemical products. For instance, some suitable carrier fluids include crude oil, naphtha, kerosene, diesel, light or heavy cycle oils, catalytic slurry oil, and gas-oils. Other potential carrier fluids can correspond to naphthenic and/or aromatics solvents, such as toluene, benzene, methylnaphthalene, cyclohexane, methylcyclohexane, and mineral oil. Still other carrier fluids can correspond to refinery fractions, such as a gas oil fraction or naphtha fraction from a coker. As yet another example, a distillate and/or gas oil boiling range fraction can be used that is generated by pyrolysis of the turf feed, either alone or with an additional feedstock. Thus, in general in view of these various non-limiting options, a conventional pyrolysis feed acting as a carrier fluid can be co-processed (thermally treated) with the turf feed.

In various embodiments, thermal treatment (e.g., pyrolysis, etc.) can be utilized to co-process a combined feedstock corresponding to a mixture of a conventional pyrolysis feed and a turf feed. Again, in some embodiments, the conventional pyrolysis feed is used as a carrier fluid for the turf feed. The conventional pyrolysis feed can correspond to one or more types of petroleum and/or renewable feeds with a suitable boiling range for cracking, such as processing in a cracker or coker. In examples, the amount of turf feed in the combined feedstock can correspond to 0.1% to 50%, or 3% to 50%, or 10% to 50% by weight of the combined feedstock. The conventional pyrolysis feedstock (e.g., conventional cracking feedstock) can correspond to 50% to 99% by weight of the combined feedstock to the thermal treatment unit (e.g., pyrolysis unit).

In some embodiments, the conventional pyrolysis feed (e.g., cracking feedstock, etc.) for co-processing with the turf feed can correspond to a conventional petroleum feedstock having a relatively high boiling fraction, such as a heavy oil feed. For example, the conventional pyrolysis feed portion (e.g., cracking feedstock) can have a T10 distillation point of 343° C. or more, or 371° C. or more. In some embodiments, the feedstock as co-feed with the turf feed can have a T10 distillation point of 343° C. to 650° C. Examples of heavy oils for inclusion in the thermal treatment feedstock (e.g., for pyrolysis, cracking, etc.) include, for example, reduced petroleum crude, petroleum atmospheric distillation bottoms, petroleum vacuum distillation bottoms, or residuum, pitch, asphalt, bitumen, other heavy hydrocarbon residues, tar sand oil, shale oil, or even a coal slurry or coal liquefaction product such as coal liquefaction bottoms. Such feeds will typically have a Conradson Carbon Residue (ASTM D189-165) of at least 5 wt %, generally from 5 wt % to 50 wt %. In some embodiments, the feed is a petroleum vacuum residuum. These are non-limiting examples and do not limit the present techniques. Other co-feeds are applicable. Again, the thermal treatment can include pyrolysis generally, fluidized bed pyrolysis, thermal cracking, coking (delayed coker or fluidized bed coker), and so on.

In addition to petroleum feedstocks, renewable feedstocks derived from biomass having an applicable boiling range can also be used as part of the feed for the thermal treatment. Such renewable feedstocks include feedstocks with a T10 boiling point of 340° C. or more and a T90 boiling point of 600° C. or less. In implementations, such biomass can be characterized as conventional pyrolysis feed.

In some particular embodiments, the turf feed and any co-fed feed (e.g., conventional pyrolysis or cracking feedstock, carrier, etc.) are mixed to form a combined feedstock prior to entering the thermal treatment environment. More generally, however, any convenient technique for introducing both the turf feed and the co-fed feed into the thermal treatment environment can be employed.

Prior to being introduced into the thermal treatment environment, with or without a co-fed feed, the feedstock can be pre-heated in implementations. Pre-heating the feedstock(s) in one or more heating stages can increase the temperature of the feedstock to a mixing and storage temperature, to a temperature related to the thermal treatment (pyrolysis or cracking) temperature, or to another convenient temperature.

In some embodiments, a portion of the pre-heating of a turf feed can be performed by mixing the turf feed with a co-fed feed in a mixing tank and heating the mixture in the mixing tank. For example, a turf feed and a co-fed feed (e.g., a cracking feedstock) can be mixed in a heated stirred tank for storage operating at 200° C. to 325° C., or 275° C. to 325° C. In some embodiments, tank agitation aids in uniform dispersal of the turf feed into resid and maintains slurry suspension. Heating in a mixing tank provides heat to the combined feedstock prior to introducing the combined feedstock into the pyrolysis reaction environment. This can reduce or minimize additional cracking heat duty that would otherwise be required to heat the turf feed to pyrolysis or thermal cracking temperatures. In addition to heating, stripping of the combined turf feed and cracking feedstock using a stripping gas can be performed in a mixing tank. Passing a stripping gas through the combined feedstock can assist with removing gases that are entrained in the combined feedstock.

Still another option can be to mix the turf feed with any co-fed feed after the pre-heater furnace for the thermal treatment (e.g., pyrolysis, etc.), in accordance with certain embodiments. In these embodiments, the co-fed feed can be heated to a higher temperature in the pre-heater, and then the turf feed can be added to the pre-heated co-fed feed to heat the turf feed.

### Thermal Treatment of Artificial Turf

In accordance with one or more embodiments, the turf feed is thermally treated (e.g., pyrolyzed) to produce more valuable thermal treatment (pyrolysis) products. Thermal treatment as pyrolysis can be a process in which larger molecules are broken down to produce smaller, more useful molecules. For example, pyrolysis (e.g., cracking) processes include thermally cracking long chain hydrocarbons (or other long chain molecules) into shorter chain molecules. Examples of pyrolysis processes include fluidized pyrolysis, coking, steam cracking, fluid catalytic cracking, etc.

The pyrolysis can generally involve thermal cracking of longer chain molecules to produce shorter chain molecules with excess carbon left behind in the form of char or petroleum coke. Where the turf feed includes inorganic filler, the inorganic filler should be segregated into char or petroleum coke.

Pyrolysis of the turf feed either alone or in combination with the conventional cracking feedstock produces pyrolysis products. In some embodiments, the pyrolysis products include a pyrolysis effluent, which may include a gas, a liquid, or a mixture thereof. The pyrolysis effluent can be fractionated or otherwise separated to form desirable product streams, such as fuel gas (e.g., C4 and lighter hydrocarbons), naphtha, diesel, gasoline, light cycle oil, and/or heavy cycle oil. In some embodiments, the pyrolysis products further include char or coke.

In some embodiments, the char or coke produced originates at least in part from turf feed, which can include an inorganic filler. Examples of suitable inorganic fillers, include sand and gravel. In these embodiments, the inorganic fillers are diverted into the coke, resulting in the char or coke including inorganic residues, such as oxides of silica or the like.

In some embodiments, the thermal treatment (e.g., pyrolysis, etc.) effluent originates at least in part from polymeric materials in the turf feed, such as thermoplastic and thermoset resins. In some embodiments, the processing of the turf feed may result in the production or recovery of olefins, or the attribution of turf feed to olefins. In some embodiments, polymers may be produced from the olefins. For example, processing of the turf feed by pyrolysis may directly produce or recover olefins used to make polymers. At least a portion of these olefins may be circular olefins that are attributable to the turf feed, such as determined by crediting, allocating, and/or offsetting or substituting for other hydrocarbons in a mass or energy balance for a system, such as in accordance with a third-party certification relating to circularity. At least a portion of these chemical products may be certified circular chemical products that are certified for their circularity by third party certification may be referred to as certified circular. One example of such a certification is the mass balance chain of custody method set forth by the International Sustainability and Carbon Certification.

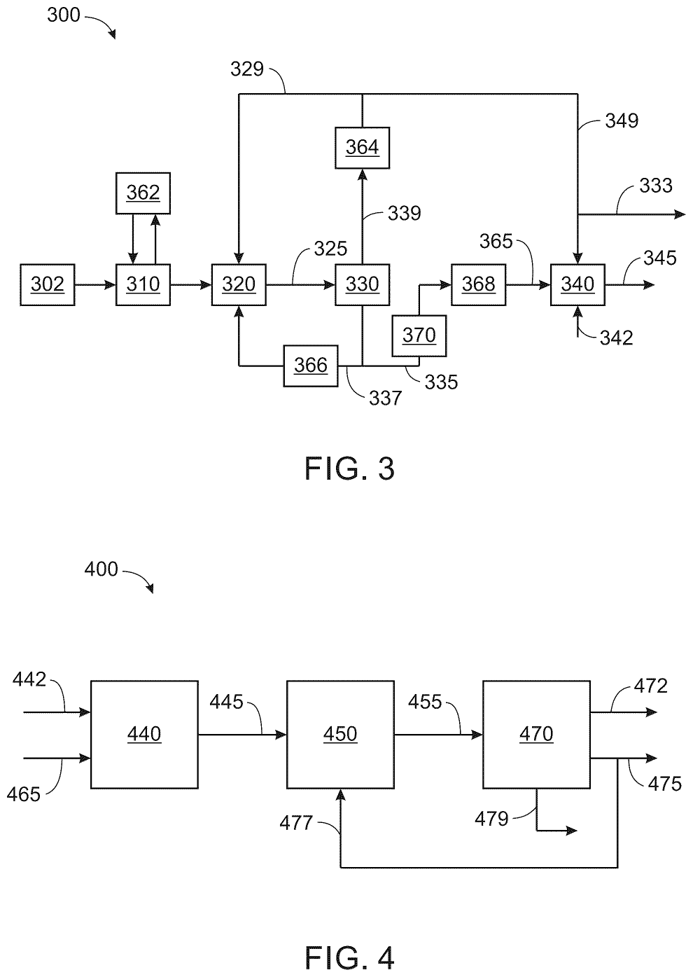

FIG. 3 is an example of a recycling process 300 for artificial turf based on integration of a thermal stage (e.g., pyrolysis), one or more contaminant removal stages, and optionally with one or more downstream conventional petrochemical processes. In implementations, thermal treatment including pyrolysis can be a technique for decomposition of organic material at elevated temperatures in the absence of oxygen into hydrocarbon and other constituents. By performing sufficient contaminant removal or conversion, existing types of petrochemical processes (such as steam cracking) can be incorporated downstream. The downstream conventional processing can include, for example, pyrolysis, steam cracking, catalytic cracking (such as fluidized catalytic cracking), and/or hydroprocessing, and so on.

High temperature thermal treatment (e.g., as conversion stage 320) is one type of recycling that can provide an efficient and robust technique of thermally treating (e.g., pyrolyzing) artificial turf and plastic waste. Unfortunately, in addition to the polymers that are desired for chemical recycle, artificial turf and plastic waste can also contain a variety of heteroatoms (i.e., non-carbon and non-hydrogen atoms).

In various aspects, after pre-processing (e.g., physical sizing) and/or initial contaminant removal performed upstream of process 300 and/or at processing 310 (e.g., physical and/or chemical processing), the artificial turf can be fed as turf feed into a thermal treatment reactor, such as a fluidized bed pyrolysis reactor, e.g., at conversion stage 320. Chemical treatment in the processing 310 can include, for example, a thermal dechlorination unit that runs at lower temperature before feeding into a higher temperature thermal reactor (pyrolysis reactor, cracking unit), e.g., at conversion stage 320. The turf feed as feedstock can be heated in the thermal treatment to a temperature in the ranges of 300° C. to 900° C., 400° C. to 900° C., 500° C. to 900° C., 400° C. to 700° C., 550° C. to 700° C., or 400° C. to 500° C., for a reaction time to perform the thermal treatment (e.g., pyrolysis). The temperature can depend in part on the desired products. For implementations of the thermal treatment as a combination of a staged pyrolysis unit, the temperature can be initially as low as 300° C., for example, in order to capture the thermal dechlorination in an initial stage of the example of block conversion stage 320 being staged pyrolysis unit. In other implementations, conversion stage 320 is not a staged pyrolysis unit, and thermal dechlorination is performed at processing 310 or not performed.

In aspects where a portion of the thermal treatment (e.g., pyrolysis) effluent from conversion stage 320 will be exposed to a second thermal cracking stage (e.g., downstream petrochemical process 340, such as steam cracking 340, etc.), lower temperatures can be used in the thermal treatment at conversion stage 320 in order to increase the yield of liquid phase products. In some aspects, the reaction time where the feedstock is maintained at or above 500° C. at conversion stage 320 can be limited in order to reduce or minimize formation of coke. In some aspects, the reaction time at conversion stage 320 (e.g., in a thermal reactor) can be in the ranges of 0.1 second to 6.0 seconds, 0.1 second to 5.0 seconds, 0.1 second to 1.0 second, 1.0 second to 6.0 seconds, 1.0 second to 5.0 second. In other aspects, some types of reactors can have longer reaction times, such as a reaction time in the ranges of 0.1 second to 120 seconds, 10 seconds to 120 seconds, 0.1 second to 90 seconds, or 10 seconds to 90 seconds. In implementations, the pyrolyzed feedstock (pyrolyzed turf feed) is cooled to below 500° C. at the end of the reaction time. For implementations of conversion stage 320 as a staged pyrolysis unit with the initial stage for thermal dechlorination and subsequent stage for the higher temperature thermal treatment (pyrolysis, cracking, etc.), the residence time of the thermal dichlorination can be, for example, in the double-digit minutes (e.g., 10 minutes to 99 minutes).

In some aspects, diluent steam can be fed into the thermal treatment (e.g., pyrolysis) reactor, e.g., at conversion stage 320. The steam also serves as a fluidizing gas. In aspects where additional diluent steam is added, the weight ratio of steam to the feedstock (e.g., turf feed) can be between 0.3:1 to 10:1.

In some aspects, the thermal treatment reactor as a pyrolysis reactor at conversion stage 320 as conversion stage can be to a fluidized bed reactor. The fluidized bed can correspond to a fluidized bed of heat transfer particles. Sand is an example of a suitable type of particle for the fluidized bed, although any convenient type of particle can be used. During operation, heated heat transfer particles can be passed into the pyrolysis reactor to provide heat for the reaction. The feedstock can be introduced separately, to avoid melting of the feedstock (e.g., turf feed). A separate fluidizing gas can also be introduced at the bottom of the reactor to maintain the fluidized bed conditions. More generally, any convenient type of pyrolysis reactor can be employed. Other examples of pyrolysis reactors include, rotary kilns, stirred tank pyrolysis reactors, screw/auger type pyrolysis reactors, thermal cracking reactors, and the like.

Most of the effluent as discharged from the thermal treatment as a pyrolysis reactor in implementations can initially be in the gas phase. Consequently, the pyrolysis effluent can be withdrawn from the top of the reactor, while cooled heat transfer particles (such as cooled sand) can be withdrawn from a location near the bottom of the fluidized bed. In implementations, vapor effluent can be condensed at separation stage 330 (and combined with any effluent in the liquid phase withdrawn from the pyrolysis reactor) to give a liquid effluent 335 (liquid product stream), separated from the non-condensed vapor effluent 339. The liquid effluent 335 can include, for example, pyrolysis oil or wax, or both, and can include heavier components (heavies). In some implementations, the liquid effluent 335 includes the heavies in a range of 1 wt % to 10 wt %. The heavies (heavy components) have a greater specific gravity (average specific gravity) or density (average density) than the remainder of the liquid effluent 335.

The heat transfer particles after exiting from the thermal treatment reactor (e.g., pyrolysis reactor), can be separated from the vapor portions of the pyrolyzed effluent using a cyclone or another solid/vapor separator. Such a separator can also remove any other solids present after pyrolysis. Optionally, in addition to a cyclone or other primary solid/vapor separator, one or more filters can be included at a location downstream from the cyclone to allow for removal of fine particles that become entrained in the vapor phase. The cooled heat transfer particles can be passed into a regenerator to be regenerated, and then returned to the reactor to provide heat for pyrolysis. Additional fuel can optionally be combusted in the regenerator to sufficiently increase the temperature of the heat transfer particles for maintenance of temperature in the fluidized bed of the pyrolysis reactor. The temperature of the heat transfer particles when leaving the regenerator can be greater than the desired temperature in the fluidized bed of the pyrolysis reactor by 50° C. or more, or 100° C. or more, such as up to 200° C. or possibly still greater. Optionally, a portion of the heat transfer particles can be purged prior to and/or after regeneration, in order to avoid build-up of other solids (e.g., char, solid halide particles, etc.) that may be present in the pyrolysis environment. In such optional aspects, a make-up stream of heat transfer particles can be added to maintain a target level of particle inventory.

The thermal treatment effluent generated from thermal treatment of the turf feed can include hydrocarbons with a range of boiling points. The thermal treatment effluent can generally include hydrocarbons ranging from C1 compound (methane) up to C60 compounds or possibly compounds including still higher numbers of carbon atoms. In some aspects, H₂ can also be present in the thermal treatment effluent.

In some aspects, the thermal treatment can be operated under conditions that allow a substantial portion of the thermal treatment effluent to correspond to higher boiling compounds. For example, the thermal treatment effluent (according to ASTM D2887) can have a T50 distillation point of 100° C. or more, or 200° C. or more, or 250° C. or more. Additionally, or alternately, the pyrolysis effluent can have a T70 distillation point of 450° C. or less, or a T80 distillation point of 450° C. or less, or a T90 distillation point of 450° C. or less. These numerical values are only given as examples and not meant to limit the present techniques. A substantial portion of the thermal treatment effluent can include compounds outside of these numerical ranges. Moreover, the thermal treatment effluent can include lower boiling compounds.

After removing solids, the products can be cooled using a heat exchanger, a quench stream, or another convenient technique, for example, to a temperature of 300° C. to 400° C. to stop the reaction. Optionally, further cooling and/or quenching can also be performed. For example, the pyrolysis effluent can be sufficiently cooled so that a liquid phase fraction of the pyrolysis effluent includes a majority of the 350+° C. products in the pyrolysis effluent. In some aspects, the cooling can be performed using a quench stream. The quench stream can be a recycle stream from another portion of the processing system, or a stream from a different processing system. For example, if the second thermal cracking process generates a distillate boiling range product (such as steam cracker gas oil), a portion of such a distillate boiling range product can be used as a quench stream. As another example, the quench stream can be a heavy portion of the pyrolysis product. After cooling the pyrolysis effluent to condense at least a portion of the effluent, the pyrolysis effluent can then be passed into a separator to separate a gas phase portion of the pyrolysis effluent from a liquid phase portion of the pyrolysis effluent. ‰

A type of contaminant removal can be a water wash. Optionally, the water wash can correspond to an amine wash and/or a caustic wash. Using an amine wash and/or a caustic wash can assist with removal of hydrogen halides as well as other contaminants, such as carbon dioxide (CO₂). Additionally, or alternately, chlorine removal can be accomplished using adsorbent beds for removal of hydrogen halides, e.g., hydrogen chloride (HCl), hydrogen bromide (HBr), etc., and/or organic halides (such as methyl chloride, vinyl chloride, and/or ethyl chloride). Examples of suitable adsorbent bed particles for removal of halogens or halides include calcium oxide, magnesium oxide, zinc oxide, and combinations thereof.

Adsorbent beds can also be used for removal of other types of contaminants. For example, another type of adsorbent bed can correspond to an adsorbent bed for removal of ammonia. In addition to nitrogen-containing polymers such as polyamides, various types of polymer additives can include nitrogen. In a pyrolysis environment, a portion of this nitrogen can be converted to HCN, acetonitrile, ammonia, and/or small amines. Various types of adsorbents are available for removal of such nitrogen compounds, such as molecular sieve-based adsorbents.

Yet another example for utilization of adsorbent beds can be to handle gas phase contaminants such as arsine, mercury, and/or phosphine. Examples of adsorbent beds for mercury (Hg) removal include adsorbent beds including refractory oxides with transition metals optionally supported on the surface, such as the oxides and metals used in demetallization catalysts or spent hydrotreating catalysts.

In the example configuration shown in FIG. 3, four separate contaminant removal stages 362, 364, 366, and 368 are shown. Individually, each of stage 362, stage 364, stage 366, and stage 368 are optional. Depending on the configuration, any one of the stages can be present, or any two, or any three, or up to all four can be present in a configuration. Each of stage 362, 364, 366, and 368 can correspond to one or more contaminant removal processes (e.g., physical separations, chemical separations, adsorbent beds, washes, hydrotreating, etc.) depending on the configuration. It is further noted that a contaminant removal stage can correspond to a single type of removal process or a plurality of processes. The contaminant(s) removed can be material or a compound not desired in the process 300, such as in the vapor product 349 or the liquid product 365, and/or not desired for operability reasons of the process 300. The “removal” can refer to conversion of the contaminant into a non-contaminant, such as via reaction (e.g., hydrotreating).

In the example configuration shown in FIG. 3, the recycling process 300 can receive a turf feed 302 (an artificial turf feed). As indicated, the term “turf feed” (which can also be called artificial turf feed) is a term to denote the artificial turf (e.g., to be recycled) as prepared for thermal treatment (e.g., pyrolysis). The turf feed 302 can be artificial turf or sized artificial turf, e.g., as sized in block 204 of FIGS. 2A and 2B, and/or sized and separated as is 210, 214, 222 of FIGS. 2A and 2B. The process 300 can include such physical processing and/or additional physical processing at block 310 and/or chemical treatment at block 310.

The processing 310 can include physical processings, such as grinding, sorting, washing, compression, and/or pelletization, and so forth. During the physical processing at block 310 if employed, some optional contaminant removal 362 (e.g., solids physical separation, vapor removal, etc.) can be performed. The processing 310 can include chemical processing.

The turf feed 302 (recycled material) can be fed to a conversion stage 320 having a thermal treatment stage or thermal treatment unit (having a thermal reactor), such as a pyrolysis stage or pyrolysis unit (having a pyrolysis reactor). The turf feed 302 can be fed through to the conversion stage through the processing 310 (if employed) as a pre-treated turf feed 302 (pre-treated recycled material). In some implementations, optionally other plastic waste (general or conventional plastic waste, e.g., targeted for recycling) and/or conventional pyrolysis feed (e.g., conventional cracking feed) may be co-fed with the turf feed 302 to the thermal treatment at the conversion stage 320.

The conversion stage 320 may include, for example, a fluidized-bed thermal pyrolysis stage (unit) or another type of pyrolysis stage (unit), a thermal cracker, a coker, etc. The conversion stage 320 produces an effluent 325 (conversion effluent 325) (e.g., a thermal treatment or pyrolysis effluent). As a non-limiting laboratory example of the pyrolysis of turf feed, see Example 1 below.

The conversion effluent 325 (which may be, for example, primarily vapor) can be processed to give a vapor effluent 339 and a liquid effluent 335. Thus, the technique can include processing the effluent 325 to give a vapor effluent 339 and a liquid effluent 335. For instance, the conversion effluent 325 can be sent to a separation stage 330 (having separation vessel and/or heat exchanger) that partially condenses and separates the effluent 325 into a vapor effluent 339 stream and a liquid effluent 335 stream. As part of separating the conversion effluent 325 at the separation stage 330, the vapor in the conversion effluent 325 can be partially condensed. The separation stage 330 can include, for example, flash drums (vessels), fractionator tower, heat exchanger, etc. In implementations, the conversion effluent 325 can include solid carryover from the conversion stage 320. These residual solids (char) can include inorganic solids (e.g., from sand infill in the turf feed 302) and organic solids (coke). The liquid effluent 335 can includes these residual solids, which may be a relatively small amount. However, in implementations, the liquid effluent 335 can be labeled as a slurry of liquid with solids.

For the liquid effluent stream 335, a portion 337 of the liquid effluent stream 335 can optionally be recycled back to the conversion stage 320. In aspects where a portion 337 of the liquid effluent stream 335 is recycled, the liquid recycle portion 337 can optionally be passed into contaminant removal stage 366 prior to returning to conversion stage 320. To remove contaminants, the equipment at contaminant removal stage 366 can include, for example, water wash, adsorption bed, hydrotreaters, cyclones, etc.

The remainder of liquid effluent stream 335 can be sent to a separator 370. The separator 370 can be or include, for example, a separator vessel, hydrocyclone, centrifuge (vessel), distillation system having a distillation column (vessel), a coalescer vessel, and the like. The separation at the separator 370 may be based on density, boiling point range, and the like. In examples, aromatic compounds (e.g., heavy aromatics) may be removed by the separator 370. For instance, compounds in the naphtha boiling point range may be preferable to heavy aromatics for the downstream petrochemical process 340 if steam cracking. The separator 370 may remove heavies, metals, and/or residual or carryover solids from the liquid effluent stream 335. The separated solids removed may include, for example, char (that can include coke) entrained in the liquid effluent stream 335 entering the separator 370. The separator 370 may remove (separate) heavies (heavy components, e.g., including hydrocarbons) and residual solids from the liquid effluent stream 335. The entering liquid effluent stream 335 can include, for example, 1 wt % to 10 wt % of heavies (heavy components having greater density than the remainder of the liquid effluent stream 335). Removal of heavies, solids, metals, etc. by the separator 370 may protect processing (e.g., hydrotreaters) in downstream contaminant removal stage 368.

The liquid effluent stream 335 (as processed in the separator 370) may pass (discharge) from the separator 370 to the contaminant removal stage 368 (e.g., a hydrotreater, water washes, etc.) to form a reduced contaminant liquid product 365. Therefore, embodiments can include contaminant removal by a separator 370 vessel before hydrotreating at stage 368 to give the liquid product 365. The hydrotreating (or combination of hydrotreating and water washes) at stage 368 may remove or convert contaminants and thus clean the liquid effluent 335 before the downstream petrochemical process 340 (e.g., steam cracking). Therefore, the liquid effluent 335 may pass through the separator 370 and then through the contaminant removal stage 368 (e.g., hydrotreater) that can convert and/or remove contaminants, for example, by hydrogenation via the hydrotreater.

The vapor effluent 339 can be passed into optional contaminant removal stage 364. It is noted that any vapor overhead from contaminant removal stage 362 can optionally also be passed into contaminant removal stage 364. After the optional contaminant removal 364, depending on the aspect, the vapor effluent can be utilized as a vapor recycle portion 329 that is returned to conversion stage 320, and/or the vapor effluent can be used as a vapor product stream 349, and/or the vapor effluent can be added to the processing train for processing of the gas phase portion of the effluent/products 345 generated by petrochemical process 340. In FIG. 3, the optional vapor product stream 349 is shown as being introduced into petrochemical process 340 (such as a steam cracker).

The reduced contaminant liquid product 365, and any optional vapor product stream 349, can then be passed into a petrochemical process 340. The reduced contaminant liquid product 365 and/or optional vapor product stream 349 can optionally be combined with one or more conventional co-feeds 342 for processing in petrochemical process 340. This can allow for production of one or more products 345. Examples of petrochemical processes can include olefin generation with a crude cracker, olefin generation with a naphtha cracker, olefin generation with a liquid cracker, olefin generation with a gas cracker, other forms of pyrolysis and/or catalytic cracking, hydroprocessing, and/or gas separation. Optionally, at least a portion 333 of vapor product stream 349 can be added to a downstream location in the processing of one or more products 345.

A configuration such as FIG. 3 provides examples of both direct fluid communication and indirect fluid communication between elements of the configuration. For example, the gas-liquid separation stage 330 shown in FIG. 3 is in direct fluid communication with conversion stage (such as a pyrolysis reactor) 320. The gas-liquid separation stage 330 can be in indirect fluid communication with the petrochemical process 340 via the separator 370 and the contaminant removal stage 368.

As discussed, in implementations, the separator 370 can remove heavy (dense) components (e.g., heavies) from the liquid effluent 335, and remove any solids present in the liquid effluent 335. The heavy components (heavies) removed can be, for example, in the range of 1 wt % to 20 wt % of the liquid effluent 335 that enters the separator 370 and generally have a greater average density or average specific gravity than the remainder of the liquid in the liquid effluent 335. The heavy components (e.g., as heavies) removed can have an average density or average specific gravity that is greater than the average density or average specific gravity of the liquid effluent 335 that enters the separator 370. The heavy components (heavies) can have an average molecular weight greater than the average molecular weight of liquid effluent 335 that enters the separator 370. The heavies removed can have viscosity greater than the viscosity of the liquid effluent 335 that enters the separator 370. The heavies or heavy components removed can have an average molecular weight greater than the average molecular weight of the constituents in the liquid effluent 335 that enters the separator 370. The heavies or heavy components may be or include, for example, linear and branched olefins (having high molecular weight), aromatics, wax, etc., and in which these heavies compounds can include a heteroatom. These compounds (e.g., hydrocarbons) that are heavies can have a number of carbon atoms in the range, for example, of 14 carbon atoms (C14) to 43 carbon atoms (C43). The heavies can be or include wax that can be further processed to produce the wax as product.

In implementations, the remaining liquid effluent 335 that discharges from the separator 370 can be generally pyrolysis oil (pyoil). The pyoil as liquid effluent discharged from the separator 370 (e.g., a separator vessel, hydrocyclone, centrifuge (vessel), distillation column, a coalescer vessel, etc.) to the hydrotreater at stage 368 can include, for example, naphtha and gas oil range molecules with some entrained heavies. The liquid effluent discharged from the separator 370 can include other components. As a non-limiting laboratory example of the centrifugal separation of heavies from pyoil for reference, see Example 2 below.

Hydroprocessing covers a range of catalytic processes including hydrotreating and hydrocracking. Catalytic hydrotreating can be a hydrogenation process. Hydrotreating as hydrogenation can increase the hydrogen content by saturating olefins and some aromatics. At contaminant removal stage 368, the liquid effluent 335 minus the heavy components removed via the separator 370 (e.g., giving the processed liquid effluent 335 as pyoil) can be hydrotreated, for instance, in a continuous flow reactor utilizing a catalyst. The catalyst can be, for example, a cobalt/molybdenum (Co/Mo) catalyst or other type of catalyst. The hydrotreating catalyst can include, for example, Mo, Co, nickel (Ni), palladium (Pd), tungsten (W), nickel (Ni), or any combinations thereof. The hydrotreating at stage 368 may be performed, for example, at a temperature in the ranges of 150° C. to 450° C., or 300° C. to 450° C., and at a pressure in the ranges of 500 psig to 1,100 psig, or 700 psig to 1,200 psig. For cases of stage 368 hydrotreating of the processed liquid effluent 335 (e.g., pyoil without the heavies removed via the separator 370) mostly or only for hydrogenating olefins, the hydrotreater operating temperature can be lower (e.g., 150° C. to 300° C.).

FIG. 4 shows additional details for a configuration that integrates turf feed pyrolysis with the example of a steam cracking process train 400. In FIG. 4, a feed 465 (for steam cracking) is passed into a steam cracking reactor 440. The feed 465 may be the reduced contaminant liquid product 365 of FIG. 3. The steam cracking reactor 440 may be analogous to the petrochemical process 340 (or component of the petrochemical process 340) of FIG. 3. In the example shown in FIG. 4, any optional removal of high molecular weight fractions from the feed 465 has generally already been performed. Optionally, the feed 465 can be combined with steam 442 and/or a conventional cracking feed (e.g., 342 of FIG. 3) prior to entering the steam cracking reactor 440. The steam cracking reactor 440 can be operated to produce monomers, such as C2-C4 olefins. Under such steam cracking conditions, the steam cracking reactor can also produce various fractions, such as steam cracked naphtha, steam cracker gas oil, and steam cracker tar.

The steam cracker effluent 445 from the steam cracking reactor 440 can then be passed into, for example, a quench stage 450 where the steam cracker effluent 445 is indirectly cooled with water and/or mixed with quench oil (such as optional quench oil 477) to cool the effluent. The quench oil can correspond to, for example, a fraction from the fractionator 470 (e.g., primary fractionator), such as a steam cracker gas oil fraction or a bottoms fraction, depending on the configuration. The quenched effluent 455 can then be passed into the fractionator 470. Optionally, the quenched effluent can be passed through a tar knockout drum or other separator (not shown) for removal of steam cracker tar prior to entering the fractionator 470.

In the example shown in FIG. 4, the primary fractionator 470 can generate a bottoms product 479 (such as steam cracker tar), one or more intermediate products (such as quench oil 477 and/or steam cracker gas oil 475), and an overhead product 472 that includes gas phase components (including olefin monomers) and steam cracker naphtha. A portion 477 of the intermediate products can be used as a quench oil. The overhead product 472 can be further processed. Optionally, a hydrotreating unit (not shown) can be used to hydrotreat at least a portion of bottoms product 479. Prior to such hydrotreating (such as hydrogenation), a guard bed can optionally be used to allow for removal of contaminants such as silica and/or metals that are contained in the bottoms product 479. Some configurations can integrate the fractionator 470 with a quench tower.

As mentioned, the overhead product 472 can be further processed, such as compressed and sent through a wash stage wash stage (water wash, caustic wash, and/or amine wash) to remove, for example, CO₂, hydrogen halides (such as HCl), alkyl halides, carbonyls, and/or ammonia (NH₃). The wash stage effluent can be passed, for example, into process gas driers and then separated to form fractions containing the component monomers. This process can be started, for instance, by passing the dried wash effluent into a de-ethanizer to give a C3+ product and a C2− product. The C2− product can be optionally passed into an acetylene conversion stage and subjected to additional processing. The C3+ product can undergo further separations to allow for recovery of C3 olefins and C4 products. A series of separations can be performed on the C3+ product. For example, the C3+ product can be passed into a depropanizer to form a C4+ product and a C3 product. The C3 product can then be split to form a C3 paraffin stream and a C3 olefin stream.

Thus, the separations may, starting with a de-ethanizer as the first of a series of separation stages for forming component monomers. In other aspects, the separation into component monomers can be performed in any convenient order. For example, instead of starting with a de-ethanizer, in another configuration the first separator can correspond to a depropanizer. In this type of configuration, the first separation forms a C3− stream and a C4+ stream, as opposed an initial separation forms a C2− stream and a C3+ stream.

Products may include C2, C3, and/or C4. After sufficient separation steps, at least one of a high purity ethylene product stream or a high purity propylene product stream can be formed from the gas phase products from the steam cracker 440 (or other second conversion stage). For example, a high purity product stream can include 99.0 wt % or more (such as up to 100 wt %) of ethylene or propylene. Such a high purity stream can then be used in an oligomerization reaction or polymerization reaction, such as for production of polymers.

An example of an oligomerization reaction is a slurry polymerization reaction, such as the slurry polymerization process described in U.S. Pat. No. 7,146,130, which is incorporated herein by reference for the limited purpose of describing a slurry polymerization process. An example of a suitable type of catalyst in a slurry polymerization process can be a Ziegler-Natta catalyst. Another example of oligomerization reaction is a continuous solution polymerization process, such as the process described in U.S. Pat. No. 9,815,913, which is incorporated herein by reference for the limited purpose of describing a continuous solution polymerization process. An example of a suitable type of catalyst for use in a continuous solution polymerization process is a metallocene catalyst.

An embodiment is a method of recycling artificial turf, including providing a turf feed comprising a sized carpet composition (e.g., including sized turf fibers comprising a thermoplastic) of an artificial turf; subjecting the turf feed to thermal treatment (e.g., pyrolysis) to produce a liquid effluent including hydrocarbons; and removing heavies and entrained solids/particulates from the liquid effluent via a separator (e.g., hydrocyclone, centrifuge, distillation column, coalescer, etc.), wherein the heavies have an average density greater than the liquid effluent that enters the separator. The term “turf feed” (or “artificial turf feed”) may be a term to denote the artificial turf as prepared for feed to thermal treatment (pyrolysis). Such preparation can include, for example, removing at least some of the inorganic infill (e.g., sand), sizing (e.g., crushing, grinding, pelletizing, etc.) the artificial turf for conveyance in a conduit and for entering through a nozzle of the thermal reactor (e.g., pyrolysis reactor), and so on. In implementations, the turf feed may enter conversion stage (e.g., 320 of FIG. 3) [e.g., a thermal treatment (pyrolysis) system] having a thermal (pyrolysis) reactor that discharges an effluent (e.g., conversion effluent 325 of FIG. 3). In implementations, this effluent can be vapor that is primarily hydrocarbons, which partially condensed to give the liquid effluent and a vapor effluent. In implementations, solids (e.g., “char”) that can be inorganic (e.g., from sand infill) and organic (e.g., coke) can have a separate discharge from the reactor than the conversion effluent discharge.

The heavies may include at least one of chloride, bromide, or fluoride. In certain implementations, the heavies are generally a liquid at flow temperature but can solidify at ambient temperature in particular implementations. In implementations, heavies are generally hydrocarbons, e.g., having a number of carbon atoms, for instance, in the range of C14 to C43. The heavies may be or include, for example, linear and branched olefins (having molecular weight as for C14+ compounds), aromatics, wax, etc., and in which these heavies compounds can include a heteroatom. The heavies can be or include wax that can be further processed to produce the wax as product.

The liquid effluent discharged from the separator without the heavies may include or be pyrolysis oil (pyoil) or wax, or both. In implementations, the method includes hydrotreating the liquid effluent discharged from the separator without the heavies removed by the separator. In implementations, the hydrotreating removes or converts contaminants in the liquid effluent. In implementations, the hydrotreating reduces the amount of olefins in the liquid effluent. In implementations, the hydrotreating converts at least some of the aromatic compounds in the liquid effluent into naphtha. The method may include providing the liquid effluent as hydrotreated to a steam cracker. The method may include generating products by steam cracking of the liquid effluent in the steam cracker and via downstream processing of vapor discharged from the steam cracker, wherein the products can include ethylene, propylene, wax, and/or lube oil.

As discussed, the method may include processing the artificial turf to give the turf feed. The turf feed can include an inorganic filler of the artificial turf. The method can include removing solids that include char from the pyrolysis, and in which the char includes char from inorganic material in the turf feed. In implementations, the turf feed includes an infill material from the artificial turf, and wherein the infill material includes a polymeric material. The sized carpet composition can include a primary backing material or a secondary backing material, or both.

Another embodiment is a method of recycling artificial turf, including providing a turf feed including a sized carpet composition of the artificial turf, and thermally pyrolyzing the turf feed to produce liquid, vapor, and char, wherein the liquid includes pyrolysis oil or wax, or both. The method includes separating the liquid from the vapor and the char, and hydrotreating the liquid to give a cracker feed for a steam cracker. In some implementations, the olefin content of the cracker feed as measured by bromine number is less than 10% of the olefin content of the liquid upstream of (or as entering) the hydrotreating before the hydrotreating. In other words, in those implementations, the hydrotreating generally converts (hydrogenates, saturates, etc.) and/or removes 90% of the olefin content from the liquid entering the hydrotreating. The hydrotreating may be performed, for example, at a pressure of at least 500 pounds per square inch gauge (psig) in the presence of a hydrotreating catalyst (e.g., including Mo and Co) to give the cracker feed. The method can include removing, via a separator, heavy components from the liquid upstream of the hydrotreating of the liquid, wherein the heavy components have a specific gravity greater than specific gravity of the liquid as entering the centrifuge. In implementations, the cracker feed comprises substantially same boiling curve as the liquid comprising the pyrolysis oil or wax, or both, after removal of the heavy components, and wherein the cracker feed comprises substantially same boiling curve as the liquid comprising the pyrolysis oil or wax, or both, after removal of the heavy components. In some implementations, the cracker feed has a chlorine content that is at least 50% less than the liquid upstream of the centrifuge. In implementations, the artificial turf and the turf feed each have at least 10% of rubber infill by weight. In implementations, the turf feed includes an inorganic filler from the artificial turf.

### ADDITIONAL EMBODIMENTS

Accordingly, the present disclosure may provide for the recycling of artificial turf that includes pyrolysis of a turf feed to produce hydrocarbons. The methods and systems may include any of the various features disclosed herein, including one or more of the following statements.

Embodiment 1. A method comprising: providing a turf feed that includes a carpet composition of an artificial turf; subjecting the artificial turf feed to thermal treatment to produce an effluent comprising hydrocarbons; and removing entrained solids and heavies comprising hydrocarbons from the liquid effluent via a separator, wherein the heavies comprise an average density greater than an average density of the liquid effluent that enters the separator.

Embodiment 2. The method of Embodiment 1, wherein the thermal treatment comprises pyrolysis, wherein the artificial turf feed comprises an infill material of the artificial turf, the infill material comprising an inorganic filler or a granulated thermoset rubber, or both.

Embodiment 3. The method of Embodiment 2, wherein the infill material comprises the inorganic filler comprising sand.

Embodiment 4. The method of Embodiment 1, wherein the carpet composition comprises a sized carpet composition.

Embodiment 5. The method of Embodiment 1, wherein the carpet composition comprises a sized carpet composition including sized turf fibers comprising a thermoplastic.

Embodiment 6. The method of Embodiment 4 or Embodiment 5, wherein the sized carpet composition comprises a primary backing material or a secondary backing material, or both.

Embodiment 7. The method of any preceding Embodiment, comprising processing the effluent to give a liquid effluent and a vapor effluent, wherein removing heavies and entrained solids from the effluent comprises removing heavies and entrained solids from the liquid effluent via the separator.

Embodiment 8. The method of Embodiment 7, comprising hydrotreating the liquid effluent discharged from the separator without the solids and the heavies removed by the separator, and wherein the hydrotreating comprises hydrogenation.

Embodiment 9. The method of Embodiment 8, wherein the hydrotreating provides for contaminant management in the liquid effluent discharged from the separator in converting and/or removing contaminants in the liquid discharged from the separator.

Embodiment 10. The method of Embodiment 9, wherein the contaminants comprise heteroatoms.

Embodiment 11. The method of Embodiment 9 or Embodiment 10, wherein the contaminants comprise halides.

Embodiment 12. The method of any one of Embodiments 8 to 11, wherein the hydrotreating reduces an amount of olefins in the liquid effluent or converts aromatic compounds in the liquid effluent into naphtha, or both.

Embodiment 13. The method of any one of Embodiments 8 to 12, comprising providing the liquid effluent as hydrotreated to a steam cracker.

Embodiment 14. The method of Embodiment 13, comprising generating products by steam cracking of the liquid effluent in the steam cracker and via downstream processing of vapor discharged from the steam cracker, wherein the products comprise ethylene or propylene, or both.

Embodiment 15. The method of any one of Embodiments 7 to 14, comprising processing the artificial turf to give the artificial turf feed, wherein the liquid effluent discharged from the separator without the heavies comprises pyrolysis oil (pyoil).

Embodiment 16. The method of Embodiment 1, wherein the effluent comprises pyoil or wax, or both, and wherein the artificial turf feed comprises an inorganic filler of the artificial turf.

Embodiment 17. The method of Embodiment 1, wherein the artificial turf feed comprises an infill material from the artificial turf, the infill material comprising a polymeric material.

Embodiment 18. The method of any preceding Embodiment, comprising removing solids comprising char from the thermal treatment, the char including from inorganic material in the artificial turf feed.

Embodiment 19. A method of recycling artificial turf, comprising: providing a turf feed comprising a sized carpet composition of the artificial turf; thermally treating the turf feed to produce liquid, vapor, and char, wherein the liquid comprises pyrolysis oil or wax, or both; separating the liquid from the vapor and the char; and hydrotreating the liquid to give a cracker feed for a steam cracker, wherein olefin content of the cracker feed as measured by bromine number is less than 50% of the olefin content of the liquid upstream of the hydrotreating.

Embodiment 20. The method of Embodiment 19, wherein thermally treating the turf feed comprises thermally pyrolyzing the turf feed, wherein the artificial turf and the turf feed each comprise at least 10% of rubber infill by weight, and wherein the turf feed comprises an inorganic filler from the artificial turf.

Embodiment 21. The method of Embodiment 19 or Embodiment 20, comprising removing, via a separator vessel, heavy components from the liquid upstream of the hydrotreating of the liquid, wherein the heavy components comprise a specific gravity greater than specific gravity of the liquid as entering the separator vessel, wherein the hydrotreating removes or converts contaminants in the liquid, and wherein the olefin content of the cracker feed as measured by the bromine number is less than 10% of the olefin content of the liquid upstream of the hydrotreating.

Embodiment 22. The method of any one Embodiments 19 to 21, wherein the cracker feed comprises substantially same boiling curve as the liquid comprising the pyrolysis oil or wax, or both, after removal of the heavy components, and wherein the cracker feed comprises substantially same specific gravity as the liquid comprising the pyrolysis oil or wax, or both, after removal of the heavy components.

To facilitate a better understanding of the present invention, the following examples of certain aspects of some embodiments are given. In no way should the following examples be read to limit, or define, the entire scope of the disclosure.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

### EXAMPLES

Examples 1-4 are presented. The Examples are not meant to limit the present techniques.

### Example 1

Pyrolysis of artificial turf was performed. The pyrolysis can be characterized as standalone pyrolysis, e.g., in that the pyrolysis was not integrated with or connected to further downstream equipment other than to characterize or process the pyrolysis effluent. A 500 milliliter (ml) non-stirring Parr reactor was loaded with approximately 210 grams (g) of artificial turf sample under a nitrogen atmosphere at ambient pressure. The Parr reactor (autoclave) is available from Parr Instrument Company having headquarters in Moline, Illinois, USA. To perform the pyrolysis, the Parr reactor having the artificial turf sample was heated to 450° C. for 4 hours (h) and the resulting dark yellow liquid product was continuously distilled into a knockout pot chilled with dry ice. At ambient temperature, the liquid product turned waxy especially with turf feed containing rubber pieces. The solid remaining in the reactor was collected after cooling down.

Table 2 summarizes the compositions of artificial turf that were used for the pyrolysis. Some of the values do not add up to 100% due to experimental limitations. The composition was determined using several independent tests and it is possible to over or under-count certain elements.

Sample A is an end-of-life turf sample from an athletic sport field that underwent water washing and was subsequently pelletized. Sample B is artificial turf an end-of-life turf sample from an athletic sport field that was also pelletized; it may of had some sand contamination likely from the original infill material. Sample C is artificial turf an end-of-life turf sample from an athletic sport field in which the grass was agglomerated but not pelletized, it had a stringy appearance form the grass fibers. Sample D is artificial turf an end-of-life turf sample from an athletic sport field, where the infill material had been removed. The carpet was shredded in the lab for further analysis.

The chemical elements given in Table 1 are chlorine (Cl), carbon (C), hydrogen (H), nitrogen (N), oxygen (O), sulfur (S), sodium (NA), mercury (Hg), and fluorine (F). The units include wt %, parts per million by weight (ppmw), and parts per billion by weight (ppbw).

TABLE 1
Composition of artificial turf

| Sample | Ash | Cl | C | H | N | O | S | C + H | Na | Hg | F |
|---|---|---|---|---|---|---|---|---|---|---|---|
| ID | wt % | ppmw | wt % | wt % | wt % | wt % | wt % | wt % | ppmw | ppbw | ppmw |
| A | 7.5 | 777 | 78.4 | 13.1 | 0.2 | 2.1 | 0 | 92 | 60 | 2.2 | 42 |
| B | 11.5 | 689 | 72.5 | 11.9 | 0.2 | 1.0 | 0 | 84 | 129 | 9.4 | 116 |
| C | 23.2 | 395 | 67.6 | 10.5 | 0.2 | 7.1 | 0 | 78 | 132 | 12.3 | 51 |
| D | 14.9 | 630 | 67.3 | 10.8 | 0.9 | 8.7 | 0 | 78 | 58 | 4.6 | 81 |

Table 2 gives the yields of gas, liquid and solid from pyrolysis of artificial turf in Example 1. The yield of gas, liquid/wax, and solid char changed with the composition of the feed (artificial turf) as summarized in the Table 2. Note that the yield of gas is based on the difference between starting mass and the sum of liquid/wax and solid char.

TABLE 2
Yield of Pyrolysis of Artificial Turf

| Sample ID | Liquid % | Solid (Char) % | Gas % |
|---|---|---|---|
| A | 79 | 9 | 12 |
| B | 24 | 21 | 55 |
| C | 58 - waxy | 32 | 10 |
| D | 38 - waxy | 28 | 34 |

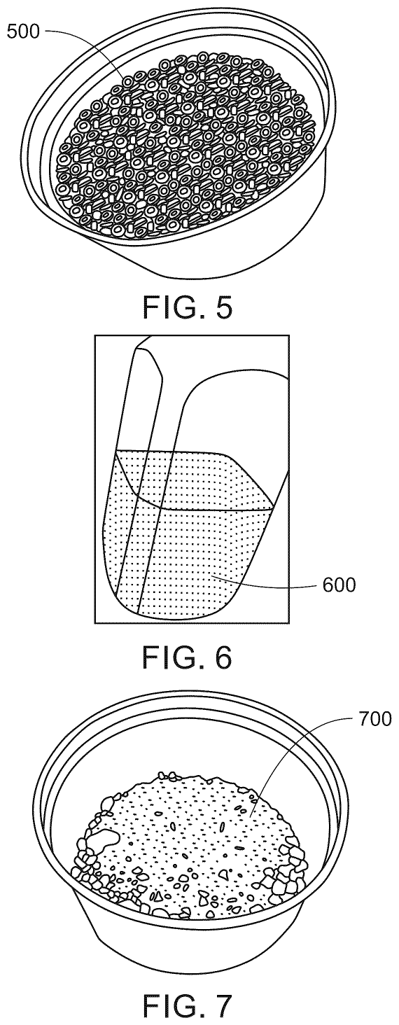

FIG. 5 is a general depiction of pellets 500 of artificial turf in Example 1 (Table 2) prior to being subjected to the pyrolysis. It should be noted that pelletizing the artificial turf for the pyrolysis may generally not be implemented. FIG. 6 is a general depiction of the pyrolysis yield of liquid 600 in Example 1 (Table 3). FIG. 7 is a general depiction of the pyrolysis yield of char 700 in Example 1 (Table 3).

FIG. 8 is a plot of char % (Table 3) after pyrolysis versus the ash wt % in the artificial turf before pyrolysis. One of the benefits of standalone pyrolysis of turf can be the management of inorganic material, such as sand infills or dirt, by rejecting (removing) the inorganic material as char after pyrolysis. The char can also include coke. The char can be purged from the reactor and disposed separately. This can facilitate avoiding pre-wash step of artificial turf which can be costly because of the extent of water use and wastewater management. FIG. 8 highlights the benefit that the ash content in the starting artificial turf feed correlates well with the amount of char left in the reactor after the pyrolysis (e.g., the first pyrolysis). In commercial implementations, the pyrolysis system (operation, process) can be continuous, batch, or semi-batch. In implementations, the liquid, vapor, and char, and in which the char may be removed continuously. In some implementations, char remains in the pyrolysis reactor until the reactor is opened and the char removed, or otherwise removed without opening the reactor. Other configurations are applicable.

### Example 2

Example 2 is directed to the removal of heavies from the liquid product of artificial turf pyrolysis. Example 2 is separation of heavies using centrifuge from liquid product of artificial turf pyrolysis. A concern with pyrolysis of artificial turf (e.g., having polymers) is instability thereby forming heavies (e.g., which may also be labeled as or including gums) in the liquid product from the pyrolysis. Since pyrolysis oil can have high olefins content and reactive heteroatoms containing molecule, all of these can react with each other to make heavies. The instability concern applies to both oxidative and non-oxidative environments. The heavies are generally heavier (greater density) than the remainder or majority of the liquid product and therefore can be labeled as heavier compounds. The heavies can cause downstream processing challenges. Heavier compounds removal can be desired in scenarios where pyrolysis is non-continuous or a batch process, or liquid product is stored or imported for further processing, and the like. Removal of the heavies can be desired in a continuous process.

The heavies (heavy components) formation was observed in liquid product from the artificial turf pyrolysis in Example 1 after a few days. In Example 2, to remove those heavies, a centrifuge was employed. Since centrifuge separation is based on density difference, any entrained solids were generally removed as well. In Example 2, the liquid product was centrifuged at 3,400 revolutions per minute (rpm) for 10 minutes. The resulting clear dark-yellow liquid (pyoil) (less dense than the heavier components as heavies) was decanted and collected leaving heavier components at the bottom of the centrifuge. The heavies were collected from the centrifuge. The heavies (heavier compounds) were approximately 5-10 weight percent (wt %) of the liquid product sample centrifuged.

FIG. 9 depicts heavies 900 and pyoil 902 (pyrolysis oil). In particular depicts the liquid product of Example 1 after being separated via centrifuge in Example 2 into the heavies 900 and the pyoil 902 (pyrolysis oil). The pyoil 902 has a lower density than the heavies 900. Again, the heavies 900 was about 5-10 wt % of the liquid product centrifuged.

In commercial processing (recycling process of artificial turf), after removal of the heavies from the pyrolysis liquid product, the resulting pyoil (liquid product minus the removed heavies) can be sent to a hydrotreater for hydrogenation of the pyoil. The hydrotreating may be, for example, hydrotreating (hydrogenation) of aromatic compounds (aromatics) to naphtha to make the pyoil more appropriate for downstream processing (e.g., steam cracking). In some implementations, the removal of the heavies 900 from the pyoil 902 may be optional. Thus, in those implementations, the pyoil 902 with the heavies 900 therein may be sent to hydrotreating.

### Example 3

Example 3 is directed to hydrotreatment of centrifuged liquid product (pyoil) from pyrolysis of artificial turf and after heavies removal. Artificial turf has inherently strong variability due to the composition and depending on the separation of rubber from the carpet part. Strong variability in the pyoil is therefore expected. The variability is exemplified in Tables 1 and 2 above.

The pyoil product from pyrolysis of artificial turf sample A was hydrotreated. The pyoil product hydrotreated in Example 3 is the liquid product from the pyrolysis of sample A in Example 1 minus the heavies removed via a centrifuge in Example 2. This pyoil product from pyrolysis of artificial turf sample A was hydrotreated in a continuous flow reactor using RT-621 cobalt/molybdenum (Co/Mo) catalyst. The catalyst was sulfided using 10% dimethyl disulfide (DMDS) in Isopar™ (synthetic isoparaffin) solution at 340° C. under hydrogen flow. The H₂:pyoil volume ratio was maintained at 5:1 and the conversion was tested at two different conditions summarized in Table 3. The hydrogen flow is given in standard cubic centimeters per minute (sccm). The pyoil feed flow rate is given in milliliters per minute (ml/min). The pressure is given in pounds per square inch gauge (psig). The amount of isothermal catalyst (RT-621 Co/Mo catalyst) is given in grams (g).

TABLE 3
Artificial Turf Pyoil Hydrotreatment Conditions

| | Condition 1 | Condition 2 |
|---|---|---|
| Temperature, ° C. | 300 | 250 |
| Pressure, psig | 1000 | 1000 |
| Isothermal Cat., g | 7.1 | 7.1 |
| Feed flow rate, ml/min | 0.1 | 0.1 |
| Hydrogen flow, sccm | 50 | 50 |

To evaluate the effectiveness of hydrotreatment of the pyoil, the parent pyoil and pyoil products after hydrotreatment were analyzed. The samples were designated as: Parent (pre hydrotreated pyoil); 250C-HT (hydrotreated at 250° C.); and 300C-HT (hydrotreated at 300° C.).

The samples were sent to a 3rd party laboratory for analysis using the following American Society for Testing and Materials (ASTM) methods (standards) of ASTM International: ASTM D4052-22 (last updated May 18, 2022) for specific gravity; ASTM D2887-22e1 (last updated Feb. 28, 2023) and ASTM D7169-23 (last updated Aug. 25, 2023) for simulated distillation (simdist); ASTM D7359-18 (last updated Apr. 24, 2023) for total halides (F, Cl, and Br) by combustion ion chromatography (CIC); ASTM D2622-21 (last updated Jan. 4, 2022) for total sulfur by x-ray fluorescence (XRF); ASTM D1159-07(2017) (last updated Nov. 8, 2023) for bromine number titration for olefin content; and a modified ASTM D8071-21 for gas chromatography with vacuum ultraviolet absorption (GC-VUV) method of high temperature (HT)-VUV for higher boiling samples above naphtha range for a breakdown of hydrocarbon classes. Unlike the original ASTM D8071-21 (last updated Aug. 26, 2021) method, the HT-VUV method lumps all saturates (paraffins, isoparaffins, and naphthenes) as one group.

The hydrotreatment temperature had impact on color of final product. After hydrotreatment at 250° C. the color of the sample changed from dark brown to light yellow, and at 300° C. the color almost became colorless (tinge of yellow). The color change is an indication of change in unsaturation of the sample after hydrotreatment. Artificial turf grass can contain colorants such as dyes or pigments that contain organic halogenates. Such organic dyes include, for example, pigment green 36 and pigment 7. In any refining process, such chlorides can lead to corrosion in downstream equipment such as crackers or other facilities. Embodiments of the present techniques address the chlorine (Cl) advantageously before integrating the pyoil with a downstream petrochemical process. The chlorine may be hydrogenated into hydrogen chloride (HCl) in the hydrotreating and the HCl removed or otherwise managed. Thus, the Cl may be managed without significant change to the pyoil composition in implementations.

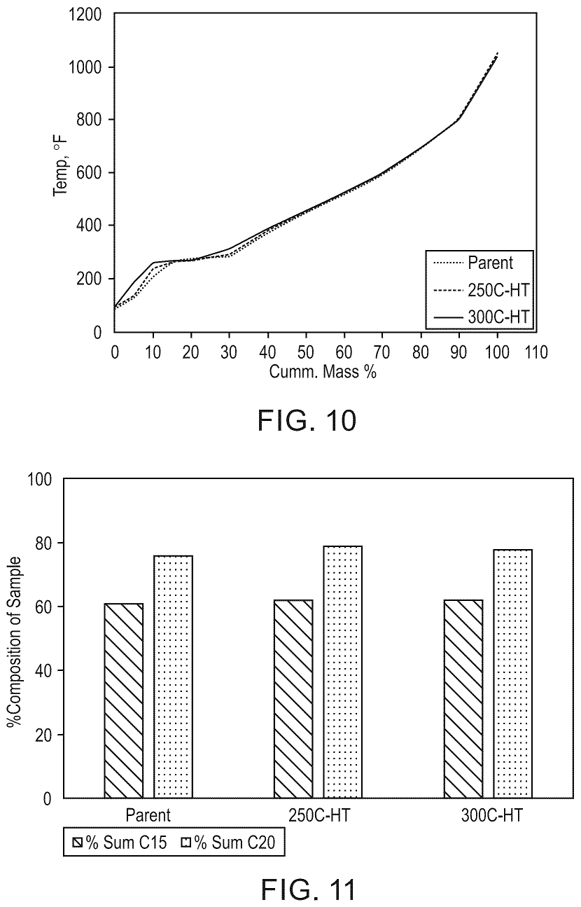

Such is exemplified, for example, in FIG. 10 by the boiling curves of the parent and hydrotreated pyoil samples. There was no significant change in the boiling point curve of the pyoil before and after hydrotreatment.

FIG. 10 is a plot of temperature (° F.) versus cumulative mass (%) giving three respective curves for the three samples: parent (pre hydrotreated pyoil); 250C-HT (hydrotreated at 250° C.); and 300C-HT (hydrotreated at 300° C.). As can be seen, the three respective curves are nearly identical. The plot can be characterized as boiling point curves of the parent pyoil and the two hydrotreated pyoil samples, respectively.

A benefit of hydrotreatment can be significant reduction of contaminants (e.g., chloride) and reactives (e.g., olefins/diolefins) as summarized in Table 4. Even though the specific gravity remained similar before and after hydrotreatment, the change in chlorine concentration and bromine number indicates effective hydrogenation. The bromine number (bromine #) is grams (g) of bromine (Br) absorbed by 100 grams (g) of the sample. The Bromine number, or bromine index, is a parameter used to estimate, for example, the amount of unsaturated aliphatic groups (olefins).

Additionally, there was no benefit observed by hydrotreatment at 350° C. compared to 250° C. In fact, lower hydrogenation temperature can be desired in order to maintain lower preheat temperature and reduce fouling.

The reduction of sulfur was not as significant as reduction of chlorine at the conditions chosen for hydrotreatment. However, % sulfur removed increased with temperature as expected, e.g., 18% removal at 250° C. and 43% removal at 300° C. While we do not know the exact source of sulfur in artificial turf feed, one potential source is the secondary infills such as rubber.

TABLE 4
Summary of key contaminants before and after
hydrotreatment of artificial turf pyoil

| | Parent | Hydrotreated - | Hydrotreated - |
|---|---|---|---|
| | Pyoil | 250° C. | 300° C. |
| Specific | 0.777 | 0.7700 | 0.7764 |
| Gravity | | | |
| F, ppmw | <1 | <0.10 | <1 |
| Cl, ppmw | 13 | <0.10 | <1 |
| S, ppmw | 36.8 | 30.1 | 20.9 |
| Bromine #, | 74.12 | 0.2 | 0.3 |
| Br g/100 g | | | |

Besides olefins and dioelfins hydrogenation, another benefit of hydrotreatment is aromatic saturation and converting to naphtha range molecules, which are appropriate feed for steam crackers. Up to 99% reduction in olefins and diolefins were achieved after hydrotreating the pyoil, which is consistent with the Bromine number reduction. Additionally, approximately greater than 40% aromatics were saturated making this stream a better steam cracker feed. Table 5 gives the saturate, olefins, and aromatics distribution for the samples per vacuum ultraviolet absorption (VUV). The PAH given in Table 5 is polycyclic aromatic hydrocarbons.

TABLE 5
Saturate, olefins, and aromatics distribution per VUV

| | Parent | Hydrotreated | Hydrotreated |
|---|---|---|---|
| | Pyoil | (250° C.) | (300° C.) |
| Total Saturates | 28.08 | 96.82 | 96.98 |
| Total Olefins | 67.2 | 0.27 | 0.29 |
| Diolefins | 4.85 | 0.06 | 0.04 |
| Total Aromatics | 4.72 | 2.92 | 1.94 |
| Mono Aromatics | 3.967 | 2.17 | 1.54 |
| PAH % | 0.76 | 0.75 | 0.4 |

FIG. 11 is a bar chart of % carbon composition of total sample. The % sum C15 and % sum C20 are given for the three samples of the parent, 250° C.-HT, and 300° C.-HT. Apart from steam cracking, the hydrotreated artificial turf pyoil can also be integrated to different areas in refinery based on the carbon range, as shown in FIG. 11.

### Example 4

A benefit of a first pyrolysis step is contaminant management. An example for bromine management is shown in Table 6. One of the sources of bromine is residual rubber from infills after sortation remaining in artificial turf feed for recycling. One of the turf samples was pyrolyzed at 530° C. for 5 minutes. The gas was cooled down to collect liquid followed by caustic scrubbing of remaining gas to remove any inorganic halides. This liquid and gas along with the char remaining in the reactor was analyzed for bromide. The concentrations of bromide are summarized in Table 6. Based on the mass balance, almost all the bromide ended up in char phase most likely from pyrolysis and secondary reactions with metal oxides such as zinc oxide (ZnO) in rubber to zinc bromide (ZnBr2). This indicates that bromine can potential get out of the process with coke and therefore may generally not impact the reliability of the process and gas and liquid products.

TABLE 6
Bromine distribution in artificial turf pyrolysis product

| | Parent | Gas | Liquid | Solid |
|---|---|---|---|---|
| Yield, wt % | | 16 | 51 | 33 |
| Br, ppmw | 38 | Not | Not | 119 |
| | | detected | detected | |

1. A method, comprising:
providing an artificial turf feed that includes a carpet composition of an artificial turf;
subjecting the artificial turf feed to thermal treatment to produce an effluent comprising hydrocarbons; and
removing heavies and entrained solids from the effluent via a separator, wherein an average density of the heavies is greater than an average density of the effluent that enters the separator.

2. The method of claim 1, wherein the thermal treatment comprises pyrolysis, and wherein the artificial turf feed comprises an infill material of the artificial turf, the infill material comprising an inorganic filler or a granulated thermoset rubber, or both.

3. The method of claim 2, wherein the infill material comprises the inorganic filler comprising sand.

4. The method of claim 1, wherein the carpet composition comprises a sized carpet composition.

5. The method of claim 1, wherein the carpet composition comprises a sized carpet composition including sized turf fibers comprising a thermoplastic.

6. The method of claim 4, wherein the sized carpet composition comprises a primary backing material or a secondary backing material, or both.

7. The method of claim 1, comprising processing the effluent to give a liquid effluent and a vapor effluent, wherein removing the heavies and the entrained solids from the effluent comprises removing the heavies and the entrained solids from the liquid effluent via the separator.

8. The method of claim 7, comprising hydrotreating the liquid effluent discharged from the separator without the entrained solids and the heavies removed by the separator, wherein the hydrotreating comprises hydrogenation.

9. The method of claim 8, wherein the hydrotreating provides for contaminant management in the liquid effluent discharged from the separator in converting and/or removing contaminants in the liquid effluent discharged from the separator.

10. The method of claim 9, wherein the contaminants comprise heteroatoms.

11. The method of claim 9, wherein the contaminants comprise halides.

12. The method of claim 8, wherein the hydrotreating reduces an amount of olefins in the liquid effluent or converts aromatic compounds in the liquid effluent into naphtha, or both.

13. The method of claim 8, comprising providing the liquid effluent as hydrotreated to a steam cracker and generating products by steam cracking of the liquid effluent in the steam cracker and via downstream processing of vapor discharged from the steam cracker, wherein the products comprise ethylene or propylene, or both.

14. The method of claim 7, comprising processing the artificial turf to give the artificial turf feed, wherein the liquid effluent discharged from the separator without the heavies comprises pyrolysis oil (pyoil), wherein the effluent comprises pyoil or wax, or both, and wherein the artificial turf feed comprises an inorganic filler of the artificial turf.

15. The method of claim 1, wherein the artificial turf feed comprises an infill material from the artificial turf, the infill material comprising a polymeric material.

16. The method of claim 1, comprising removing solids comprising char from the thermal treatment, the char including from inorganic material in the artificial turf feed.

17. A method of recycling artificial turf, comprising:
providing a turf feed comprising a sized carpet composition of the artificial turf;
thermally treating the turf feed to produce liquid, vapor, and char, wherein the liquid comprises pyrolysis oil or wax, or both;
separating the liquid from the vapor and the char; and
hydrotreating the liquid to give a cracker feed for a steam cracker, wherein olefin content of the cracker feed as measured by bromine number is less than 50% of the olefin content of the liquid upstream of the hydrotreating.

18. The method of claim 17, wherein thermally treating the turf feed comprises thermally pyrolyzing the turf feed, wherein the artificial turf and the turf feed each comprise at least 10% of rubber infill by weight, and wherein the turf feed comprises an inorganic filler from the artificial turf.

19. The method of claim 17, comprising removing, via a separator vessel, heavy components from the liquid upstream of the hydrotreating of the liquid, wherein the heavy components comprise an average specific gravity greater than am average specific gravity of the liquid as entering the separator vessel, wherein the hydrotreating removes or converts contaminants in the liquid, and wherein the olefin content of the cracker feed as measured by bromine number is less than 10% of the olefin content of the liquid upstream of the hydrotreating.

20. The method of claim 17, wherein the cracker feed comprises substantially same boiling curve as the liquid comprising the pyrolysis oil or wax, or both, after the removing of the heavy components, and wherein the cracker feed comprises substantially same specific gravity as the liquid comprising the pyrolysis oil or wax, or both, after the removing of the heavy components.
